(19) United States
(12) Patent Application Publication
(10) Pub. No.: US 2025/0004243 A1
(43) Pub. Date: Jan. 2, 2025

(54) LENS DRIVING DEVICE AND CAMERA DEVICE COMPRISING SAME

(71) Applicant: LG INNOTEK CO., LTD., Seoul (KR)

(72) Inventor: Sung Guk LEE, Seoul (KR)

(21) Appl. No.: 18/709,673

(22) PCT Filed: Nov. 21, 2022
(86) PCT No.: PCT/KR2022/018413

§ 371 Date: May 13, 2024

(30) Foreign Application Priority Data
Nov. 25, 2021 (KR) 10-2021-0164262

(51) Int. Cl. G02B 7/10; G02B 15/14; G02B 27/64

(52) U.S. Cl. CPC G02B 7/102; G02B 15/14; G02B 27/646

(57) ABSTRACT

An embodiment of the prevent invention discloses a lens driving device comprising: a housing including a first housing member and a second housing member that is coupled to the first housing member and includes a first sub-housing and a second sub-housing; a first lens assembly that is coupled to the first sub-housing and moves in the axial direction, and a second assembly that is coupled to the second sub-housing and moves in the axial direction; and a driving unit that moves the first lens assembly and the second lens assembly.

### CROSS-REFERENCE TO RELATED PATENT APPLICATIONS

This application is a U.S. National Stage Application under 35 U.S.C. § 371 of PCT Application No. PCT/KR2022/018413, filed Nov. 21, 2022, which claims priority to Korean Patent Application No. 10-2021-0164262, filed Nov. 25, 2021, whose entire disclosures are hereby incorporated by reference.

### TECHNICAL FIELD

The present invention relates to a lens driving device and a camera device including the same.

### BACKGROUND ART

A camera is a device for taking pictures or videos by capturing images of subjects and is mounted on mobile devices, drones, vehicles, or the like. To improve the quality of the image, a camera device may have an image stabilizer (IS) function for correcting or preventing an image shake caused by the movement of a user, an auto focusing (AF) function for aligning a focal length of a lens by automatically adjusting an interval between an image sensor and the lens, and a zooming function for capturing an image of a remote subject by increasing or decreasing the magnification of an image of the remote subject through a zoom lens.

Meanwhile, a pixel density of the image sensor increases as a resolution of the camera increases, and thus a size of the pixel becomes smaller, and as the pixel becomes smaller, the amount of light received for the same time decreases. Therefore, as the camera has a higher pixel density, the image shake caused by hand shaking due to a shutter speed decreased in a dark environment may more severely occur. As a representative IS technique, there is an optical image stabilizer (OIS) technique of correcting motion by changing a path of light.

According to a general OIS technique, the motion of the camera may be detected through a gyro sensor or the like, and a lens may tilt or move, or a camera device including a lens and an image sensor may tilt or move based on the detected motion. When the lens or the camera device including the lens and the image sensor tilts or moves for an OIS, it is necessary to additionally secure a space for tilting or moving around the lens or the camera device.

Meanwhile, an actuator for an OIS may be disposed near the lens. In this case, the actuator for an OIS may include actuators, which are in charge of tilting of two axes perpendicular to an optical axis Z, that is, an actuator in charge of X-axis tilting and an actuator in charge of Y-axis tiling.

However, according to the needs of ultra-slim and ultra-small camera devices, there is a large space constraint for arranging the actuator for an OIS, and it may be difficult to ensure a sufficient space where the lens or the camera device including the lens and the image sensor itself may tilt or move for an OIS. In addition, as the camera has a higher pixel density, it is preferable that a size of the lens be increased to increase the amount of received light, and there may be a limit to increasing the size of the lens due to a space occupied by the actuator for an OIS.

In addition, when the zooming function, the AF function, and an OIS function are all included in the camera device, there is a problem that magnetic field interference occurs because an OIS magnet and an AF or zoom magnet are disposed close to each other.

In addition, there is a problem that a process of performing active alignment so that the lens is accurately positioned on the image sensor becomes complicated.

### DISCLOSURE

### Technical Problem

The present invention is directed to providing a lens driving device and a camera device, in which a housing is divided to easily tilt with respect to an optical axis through protrusions and holes.

In addition, the present invention is directed to providing a lens driving device and a camera device, which provide improved optical performance as tilting is easily performed when the divided housings are coupled.

In addition, the present invention is directed to providing a lens driving device and a camera device in which the divided housing is tilted with respect to an optical axis.

In addition, the present invention is directed to providing a lens driving device and a camera device applicable to ultra-slim, ultra-small, and high-resolution cameras.

The objects of embodiments are not limited thereto and may also include objects or effects that may be identified from the configurations or embodiments to be described below.

### Technical Solution

A lens driving device according to an embodiment of the present invention includes a housing including a first housing member, and a second housing member that is coupled to the first housing member and includes a first sub-housing and a second sub-housing, a first lens assembly coupled to the first sub-housing to move in an optical axis direction, and a second lens assembly coupled to the second sub-housing to move in the optical axis direction, and a driving unit configured to move the first lens assembly and the second lens assembly.

At least one of the first sub-housing and the second sub-housing may be tilted at a predetermined angle with respect to the optical axis direction or the first housing member.

A distance between the first sub-housing and the second sub-housing may increase or decrease in the optical axis direction.

Any one of the first sub-housing and the second sub-housing may include a coupling protrusion extending in a horizontal direction, and the other may include a coupling groove in which the coupling protrusion is accommodated, and a maximum width of the coupling protrusion may be smaller than a minimum width of the coupling groove.

An outer surface of the coupling protrusion and an inner surface of the coupling groove may be spaced apart from each other.

The coupling protrusion may include an upper coupling protrusion and a bottom coupling protrusion, wherein the upper coupling protrusion may be provided as a plurality of upper coupling protrusions, and at least some of the upper coupling protrusions may overlap each other in the optical axis direction.

An upper surface of the upper coupling protrusion and a bottom surface of the coupling groove corresponding to the upper coupling protrusion may be spaced apart from each other in the horizontal direction.

The upper coupling protrusion may include a first upper protrusion and a second upper protrusion spaced apart from each other in the optical axis direction, and a length of the first upper protrusion may be equal to a length of the second upper protrusion.

A distance between an upper surface of the first upper protrusion and a bottom surface of a coupling groove corresponding to the first upper protrusion may differ from a distance between an upper surface of the second upper protrusion and a bottom surface of a coupling groove corresponding to the second upper protrusion.

At least any one of the first sub-housing and the second sub-housing may include a bonding groove disposed in a surface facing the other or in an inner surface thereof.

### Advantageous Effects

According to embodiments of the present invention, it is possible to implement a lens driving device and a camera device, in which a housing can be divided to easily tilt with respect to an optical axis through protrusions and holes.

In addition, according to the present invention, it is possible to implement the lens driving device and the camera device, which provide improved optical performance as tilting is easily performed when the divided housings are coupled.

In other words, according to the present invention, any one of a second lens assembly and a third lens assembly can be tilted with respect to a first lens assembly, and at least two of the first lens assembly, the second lens assembly, and the third lens assembly can be spaced apart from each other.

In addition, according to the present invention, it is possible to implement the lens driving device and the camera device in which the divided housing is tilted with respect to an optical axis.

In addition, according to the present invention, it is possible to implement the lens driving device and the camera device applicable to ultra-slim, ultra-small, and high-resolution cameras.

Various and beneficial advantages and effects of the present invention are not limited to the above-described contents and will be more readily understood in a process of describing specific embodiments of the present invention.

### DESCRIPTION OF DRAWINGS

FIG. 1 is a perspective view of a camera device according to an embodiment.

FIG. 2 is an exploded perspective view of the camera device according to the embodiment.

FIG. 3 is a cross-sectional view along line AA′ in FIG. 1.

FIG. 4 is an exploded perspective view of a first camera actuator according to the embodiment.

FIG. 5 is a perspective view of the first camera actuator according to the embodiment from which a shield can and a board are removed.

FIG. 6A is a cross-sectional view along line BB′ in FIG. 5.

FIG. 6B is a cross-sectional view along line CC′ in FIG. 5.

FIG. 7A is an exploded perspective view of a first camera actuator according to another embodiment.

FIG. 7B is one cross-sectional view of the first camera actuator according to another embodiment.

FIG. 7C is another cross-sectional view of the first camera actuator according to another embodiment.

FIG. 8 is a perspective view of a second camera actuator according to an embodiment.

FIG. 9 is an exploded perspective view of the second camera actuator according to the embodiment.

FIG. 10 is a cross-sectional view along line DD′ in FIG. 8.

FIGS. 11 and 12 are views for describing each driving operation of a lens assembly according to an embodiment.

FIG. 13 is a view for describing a driving operation of the second camera actuator according to the embodiment.

FIG. 14 is a schematic diagram showing a circuit board according to an embodiment.

FIG. 15A is one perspective view of a first housing member according to an embodiment.

FIG. 15B is another perspective view of the first housing member according to the embodiment.

FIG. 16A is a perspective view of a second housing according to an embodiment.

FIG. 16B is an exploded perspective view of the second housing member according to the embodiment.

FIG. 16C is a perspective view of a first sub-housing of the second housing member according to the embodiment.

FIG. 16D is a perspective view of a second sub-housing of the second housing member according to the embodiment.

FIG. 16E is a side view of the second sub-housing of the second housing member according to the embodiment.

FIG. 17 is a view along line EE′ in FIG. 11.

FIG. 18 is a view along line FF′ in FIG. 11.

FIG. 19 is a view along line GG′ in FIG. 11.

FIG. 20 is a view along line HH′ in FIG. 11.

FIG. 21 is a view along line II′ in FIG. 11.

FIG. 22 is a view along line JJ′ in FIG. 11.

FIG. 23 is a cross-sectional view of a second camera actuator according to an embodiment.

FIG. 24 is a cross-sectional view of one aspect of the second camera actuator according to the embodiment.

FIG. 25 is a cross-sectional view of another aspect of the second camera actuator according to the embodiment.

FIG. 26 is a cross-sectional view of still another aspect of the second camera actuator according to the embodiment.

FIG. 27 is a perspective view of a mobile terminal to which the camera device according to the embodiment is applied.

FIG. 28 is a perspective view of a vehicle to which the camera device according to the embodiment is applied.

### MODES OF THE INVENTION

Since the present invention may have various changes and various embodiments, specific embodiments are shown and described in the accompanying drawings.

However, it should be understood that this is not intended to limit the present invention to specific embodiments and includes all modifications, equivalents, and substitutes included in the spirit and technical scope of the present invention.

Terms including ordinal numbers such as second or first may be used to describe various components, but the components are not limited by the terms. The terms are used only for the purpose of distinguishing one component from another. For example, a second component may be referred to as a first component, and similarly, the first component may also be referred to as the second component without departing from the scope of the present invention. The term “and/or” includes a combination of a plurality of related listed items or any of the plurality of related listed items.

When a first component is described as being “connected” or “coupled” to a second component, it should be understood that the first component may be directly connected or coupled to the second component or a third component may be present therebetween. On the other hand, when the first component is described as being “directly connected” or “directly coupled” to the second component, it should be understood that the third component is not present therebetween.

The terms used in the application are only used to describe specific embodiments and are not intended to limit the present invention. The singular expression includes the plural expression unless the context clearly dictates otherwise. In the application, it should be understood that terms “include” and “have” are intended to specify that a feature, a number, a step, an operation, a component, a part, or a combination thereof described in the specification is present, but do not preclude the possibility of the presence or addition of one or more other features, numbers, steps, operations, components, parts, or combinations thereof.

Unless defined otherwise, all terms used herein, including technical or scientific terms, have the same meaning as commonly understood by those of ordinary skill in the art to which the present invention pertains. Terms such as those defined in a commonly used dictionary should be construed as having a meaning consistent with the meaning in the context of the related art and should not be construed in an ideal or excessively formal meaning unless explicitly defined in the application.

Hereinafter, embodiments will be described in detail with reference to the accompanying drawings, and the same or corresponding components are denoted by the same reference numeral regardless of the reference numerals, and overlapping descriptions thereof will be omitted.

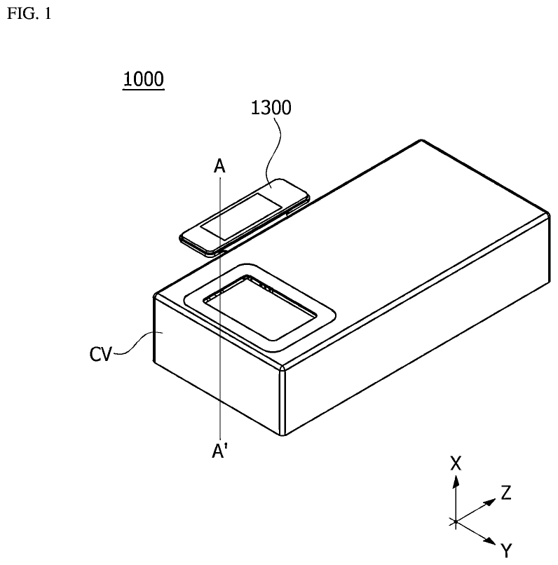

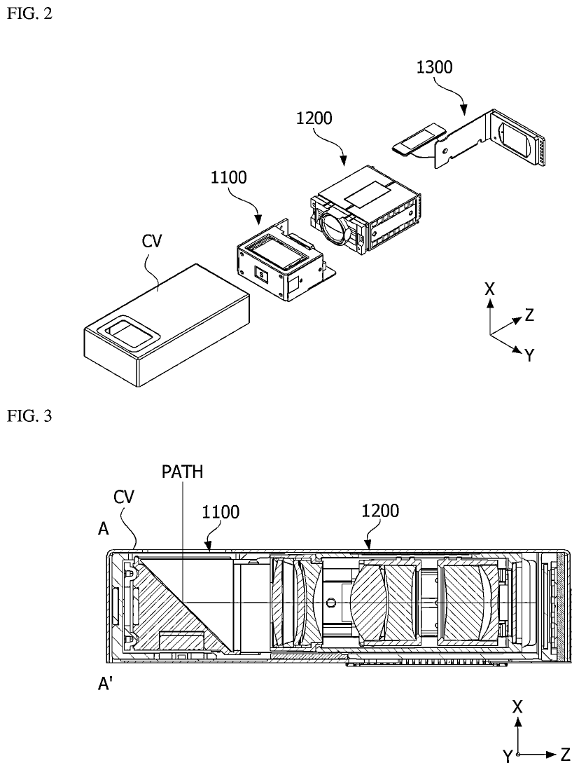

FIG. 1 is a perspective view of a camera device according to an embodiment, FIG. 2 is an exploded perspective view of the camera device according to the embodiment, and FIG. 3 is a cross-sectional view along line AA′ in FIG. 1.

Referring to FIGS. 1 and 2, a camera device 1000 according to the embodiment may include a cover CV, a first camera actuator 1100, a second camera actuator 1200, and a circuit board 1300. Here, the first camera actuator 1100 may be used interchangeably with “first actuator,” and the second camera actuator 1200 may be used interchangeably with “second actuator.” In addition, the second camera actuator 1200 may be used interchangeably with “lens driving device,” “lens driving unit,” “lens driving module,” “lens transport device,” “lens moving device,” or the like. Furthermore, the camera device 1000 may also be referred to as “camera module,” “camera unit,” “imaging device,” “imaging module,” “imaging unit,” or the like.

The cover CV may cover the first camera actuator 1100 and the second camera actuator 1200. It is possible to increase a coupling strength between the first camera actuator 1100 and the second camera actuator 1200 by the cover CV.

Furthermore, the cover CV may be made of a material which blocks electromagnetic waves. Therefore, it is possible to easily protect the first camera actuator 1100 and the second camera actuator 1200 in the cover CV.

In addition, the first camera actuator 1100 may be an optical image stabilizer (OIS) actuator.

The first camera actuator 1100 may include a fixed focal length lens disposed in a predetermined barrel (not shown). The fixed focal length lens may be referred to as “single focal length lens” or “single lens.”

The first camera actuator 1100 may change an optical path. In an embodiment, the first camera actuator 1100 may vertically change the optical path through an internal optical member (e.g., a prism or a mirror). With this configuration, even when a thickness of a mobile terminal decreases, a configuration of a lens which is larger than the thickness of the mobile terminal is disposed in the mobile terminal so that zooming, auto focusing (AF), and OIS functions may be performed through the change in the optical path.

The second camera actuator 1200 may be disposed at a rear end of the first camera actuator 1100. The second camera actuator 1200 may be coupled to the first camera actuator 1100. In addition, the mutual coupling may be performed in any of various methods.

In addition, the second camera actuator 1200 may be a zoom actuator or an AF actuator. For example, the second camera actuator 1200 may support one lens or a plurality of lenses and perform an AF function or a zooming function by moving the lenses according to a predetermined control signal of a control unit.

The circuit board 1300 may be disposed at a rear end of the second camera actuator 1200. The circuit board 1300 may be electrically connected to the second camera actuator 1200 and the first camera actuator 1100. In addition, a plurality of circuit boards 1300 may be provided.

The camera device according to the embodiment may be formed of one camera device or a plurality of camera devices. For example, the plurality of camera devices may include a first camera device and a second camera device.

In addition, the first camera device may include one actuator or a plurality of actuators. For example, the first camera device may include the first camera actuator 1100 and the second camera actuator 1200.

In addition, the second camera device may include an actuator (not shown) disposed in a predetermined housing (not shown) and capable of driving a lens unit. Description will be made based on this, but the description can be made as the concept in which the lens unit is included in the actuator. In addition, the actuator may be a voice coil motor, a micro actuator, a silicon actuator, and the like and applied in various methods such as an electrostatic method, a thermal method, a bimorph method, and an electrostatic force method, but the present invention is not limited thereto. In addition, in the specification, the camera actuator may be referred to as “actuator” or the like. In addition, the camera device formed of the plurality of camera devices may be mounted in various electronic devices such as a mobile terminal.

Referring to FIG. 3, the camera device according to the embodiment may include the first camera actuator 1100 for performing the OIS function and the second camera actuator 1200 for performing the zooming function and the AF function.

Light may enter the camera device through an opening area positioned in an upper surface of the first camera actuator 1100. In other words, the light may enter the first camera actuator 1100 in an optical axis direction (e.g., an X-axis direction), and the optical path may be changed in a vertical direction (e.g., a Z-axis direction) through the optical member. In addition, the light may pass through the second camera actuator 1200 and enter an image sensor IS positioned at one end of the second camera actuator 1200 (PATH).

In the specification, a bottom surface indicates one side in a first direction. In addition, the first direction is the X-axis direction in the drawings and can be used interchangeably with a second axis direction or the like. A second direction is a Y-axis direction in the drawings and can be used interchangeably with a first axis direction or the like. The second direction is a direction perpendicular to the first direction. In addition, the third direction is the Z-axis direction in the drawings and can be used interchangeably with a third axis direction or the like. The third direction is perpendicular to both the first direction and the second direction. Here, the third direction (Z-axis direction) corresponds to the optical axis direction, and the first direction (X-axis direction) and the second direction (Y-axis direction) are directions perpendicular to an optical axis and may be tilted by the second camera actuator. Detailed description thereof will be made below. In addition, hereinafter, the first direction (X-axis direction) can be used interchangeably with “vertical direction.” In addition, hereinafter, the second direction (Y-axis direction) can be used interchangeably with “horizontal direction.” In addition, hereinafter, the third direction (Z-axis direction) can be used interchangeably with “optical axis direction.”

In addition, hereinafter, the optical axis direction is the third direction (Z-axis direction) in the description of the first camera actuator 1100 and the second camera actuator 1200, and the following description will be made based on this.

In addition, with this configuration, the camera device according to the embodiment may resolve the spatial limitations of the first camera actuator and the second camera actuator by changing the optical path. In other words, the camera device according to the embodiment may extend the optical path while minimizing the thickness of the camera device in response to the change in the optical path. Furthermore, it should be understood that the second camera actuator may provide a high range of magnification by controlling a focus or the like in the extended optical path.

In addition, the camera device according to the embodiment can implement an OIS by controlling the optical path through the first camera actuator, thereby minimizing the occurrence of a decentering or tilting phenomenon and providing the best optical characteristics.

Furthermore, the second camera actuator 1200 may include an optical system (lens unit) and a lens driving unit. For example, at least one of a first lens assembly, a second lens assembly, a third lens assembly, and a guide pin may be disposed in the second camera actuator 1200.

In addition, the second camera actuator 1200 may include a coil and a magnet to perform a high-magnification zooming function.

For example, although the first lens assembly and the second lens assembly may be moving lenses which move through the coil, the magnet, and the guide pin, and the third lens assembly may be a fixed lens, but the present invention is not limited thereto. For example, the third lens assembly may perform a function of a focator by which light forms an image at a specific position, and the first lens assembly may perform a function of a variator for re-forming an image formed by the third lens assembly, which is the focator, at another position. Meanwhile, the first lens assembly may be in a state in which a magnification change is large because a distance to a subject or an image distance is greatly changed, and the first lens assembly, which is the variator, may play an important role in a focal length or magnification change of the optical system. Meanwhile, imaging points of an image formed by the first lens assembly, which is the variator, may be slightly different depending on a position. Therefore, the second lens assembly may perform a position compensation function for the image formed by the variator. For example, the second lens assembly may perform a function of a compensator for accurately forming an image at an actual position of the image sensor using the imaging points of the image formed by the first lens assembly which is the variator. For example, the first lens assembly and the second lens assembly may be driven by an electromagnetic force generated by the interaction between the coil and the magnet. The above description may be applied to a lens assembly to be described below. In addition, an additional lens assembly (e.g., a fourth lens assembly) may be further present.

Meanwhile, when the OIS actuator and the AF or zoom actuator are disposed according to the embodiment of the present invention, it is possible to prevent magnetic field interference with an AF or zoom magnet when an OIS is driven. Since a driving magnet of the first camera actuator 1100 is disposed separately from the second camera actuator 1200, it is possible to prevent magnetic field interference between the first camera actuator 1100 and the second camera actuator 1200. In the specification, an OIS can be used interchangeably with terms such as hand shaking correction, optical image stabilization, optical image correction, or shaking correction.

FIG. 3 is a perspective view of a camera device according to another embodiment.

Referring to FIG. 3, as described above, a lens driving device to be described below may be mounted on a camera device 1000A for performing zooming, AF, or the like without changing an optical path as well as the camera device which changes the optical path through the optical member.

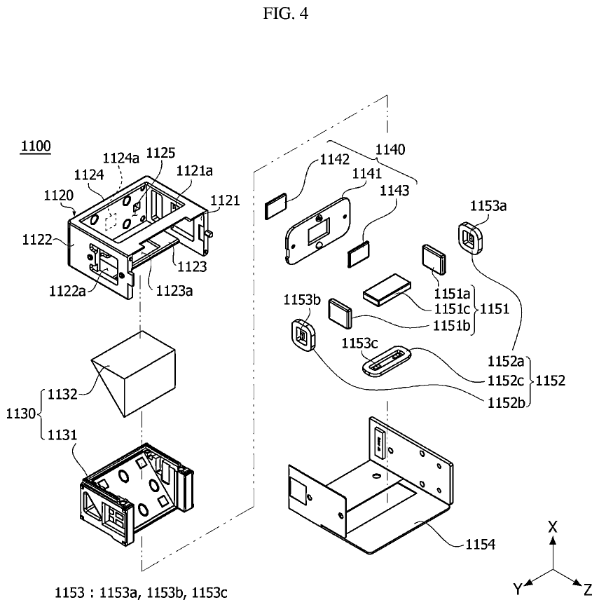

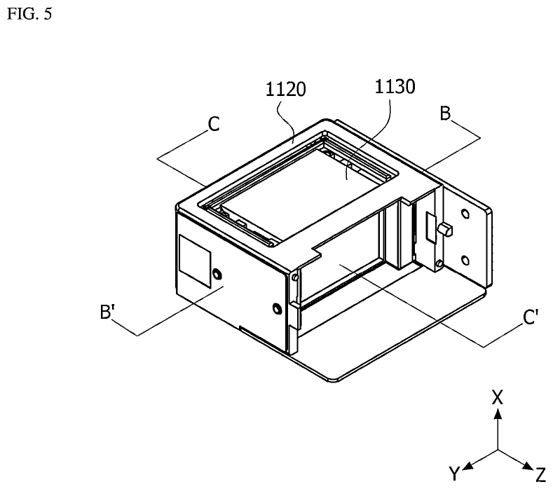

FIG. 4 is an exploded perspective view of a first camera actuator according to an embodiment.

Referring to FIG. 4, the first camera actuator 1100 according to the embodiment includes a first shield can (not shown), a first housing 1120, a mover 1130, a rotating unit 1140, and a first driving unit 1150.

The mover 1130 may include a holder 1131 and an optical member 1132 seated on the holder 1131. In addition, the rotating unit 1140 includes a tilting guide unit 1141, a first magnet 1142 having a coupling strength with the tilting guide unit 1141, and a second magnet 1143 positioned in the tilting guide unit 1141. In addition, the first driving unit 1150 includes a driving magnet 1151, a driving coil 1152, a Hall sensor unit 1153, and a first board unit 1154.

The first shield can (not shown) may be positioned at an outermost side of the first camera actuator 1100 to surround the rotating unit 1140 and the first driving unit 1150, which will be described below.

The first shield can (not shown) can block or reduce electromagnetic waves generated from the outside. Therefore, it is possible to reduce the occurrence of malfunction in the rotating unit 1140 or the first driving unit 1150.

The first housing 1120 may be positioned inside the first shield can (not shown). In addition, the first housing 1120 may be positioned inside the first board unit 1154 to be described below. The first housing 1120 may be fastened by being fitted into or matched with the first shield can (not shown).

The first housing 1120 may be formed of a plurality of housing side portions. The first housing 1120 may include a first housing side portion 1121, a second housing side portion 1122, a third housing side portion 1123, and a fourth housing side portion 1124.

The first housing side portion 1121 and the second housing side portion 1122 may be disposed to face each other. In addition, the third housing side portion 1123 and the fourth housing side portion 1124 may be disposed between the first housing side portion 1121 and the second housing side portion 1122.

The third housing side portion 1123 may be in contact with the first housing side portion 1121, the second housing side portion 1122, and the fourth housing side portion 1124. In addition, the third housing side portion 1123 may be a bottom side portion of the first housing 1120 and may include a bottom surface.

In addition, the first housing side portion 1121 may include a first housing hole 1121a. A third coil 1152a to be described below may be positioned in the first housing hole 1121a.

In addition, the second housing side portion 1122 may include a second housing hole 1122a. In addition, a fourth coil 1152b to be described below may be positioned in the second housing hole 1122a.

The third coil 1152a and the fourth coil 1152b may be coupled to the first board unit 1154. In an embodiment, the third coil 1152a and the fourth coil 1152b may be electrically connected to the first board unit 1154 to allow a current to flow therebetween. The current is an element of an electromagnetic force capable of tilting the first camera actuator with respect to an X-axis.

In addition, the third housing side portion 1123 may include a third housing hole 1123a. A fifth coil 1152c to be described below may be positioned in the third housing hole 1123a. The fifth coil 1152c may be coupled to the first board unit 1154. In addition, the fifth coil 1152c may be electrically connected to the first board unit 1154 to allow a current to flow therebetween. The current is an element of an electromagnetic force capable of tilting the first camera actuator with respect to a Y-axis.

The fourth housing side portion 1124 may include a first housing groove 1124a. The first magnet 1142 to be described below may be disposed in an area facing the first housing groove 1124a. Therefore, the first housing 1120 may be coupled to the tilting guide unit 1141 by a magnetic force or the like.

In addition, the first housing groove 1124a according to the embodiment may be positioned on an inner surface or outer surface of the fourth housing side portion 1124. Therefore, the first magnet 1142 may also be disposed to correspond to a position of the first housing groove 1124a.

In addition, the first housing 1120 may include an accommodating part 1125 formed by the first to fourth housing side portions 1121 to 1124. The mover 1130 may be positioned in the accommodating part 1125.

The mover 1130 may include the holder 1131 and the optical member 1132 seated on the holder 1131.

The holder 1131 may be seated in the accommodating part 1125 of the first housing 1120. The holder 1131 may include a first prism outer surface to a fourth prism outer surface respectively corresponding to the first housing side portion 1121, the second housing side portion 1122, the third housing side portion 1123, and the fourth housing side portion 1124.

A seating groove in which the second magnet 1143 may be seated may be disposed in the fourth prism outer surface facing the fourth housing side portion 1124.

The optical member 1132 may be seated on the holder 1131. To this end, the holder 1131 may have a seating surface, and the seating surface may be formed by an accommodating groove. The optical member 1132 may include a reflector disposed therein. However, the present invention is not limited thereto. In addition, the optical member 1132 may reflect light reflected from the outside (e.g., an object) into the camera device. In other words, the optical member 1132 can resolve the spatial limitations of the first camera actuator and the second camera actuator by changing the path of the reflected light. Therefore, it should be understood that the camera device may provide a high range of magnification by extending the optical path while minimizing a thickness thereof.

The rotating unit 1140 includes the tilting guide unit 1141, the first magnet 1142 having a coupling strength with the tilting guide unit 1141, and the second magnet 1143 positioned in the tilting guide unit 1141.

The tilting guide unit 1141 may be coupled to the mover 1130 and the first housing 1120. The tilting guide unit 1141 may include an additional magnet (not shown) positioned therein.

In addition, the tilting guide unit 1141 may be disposed adjacent to the optical axis. Therefore, the actuator according to the embodiment may easily change the optical path according to first-axis tilting and second-axis tilting, which will be described below.

The tilting guide unit 1141 may include first protruding portions disposed to be spaced apart from each other in the first direction (X-axis direction) and second protruding portions disposed to be spaced apart from each other in the second direction (Y-axis direction). In addition, the first protruding portion and the second protruding portion may protrude in opposite directions. Detailed description thereof will be made below.

In addition, the first magnet 1142 includes a plurality of yokes, and the plurality of yokes may be positioned to face each other with respect to the tilting guide unit 1141. In the embodiment, the first magnet 1142 may include a plurality of facing yokes. In addition, the tilting guide unit 1141 may be positioned between the plurality of yokes.

As described above, the first magnet 1142 may be positioned in the first housing 1120. In addition, as described above, the first magnet 1142 may be seated on the inner surface or outer surface of the fourth housing side portion 1124. For example, the first magnet 1142 may be seated in a groove formed in the outer surface of the fourth housing side portion 1124. Alternatively, the first magnet 1142 may be seated in the first housing groove 1124a.

In addition, the second magnet 1143 may be positioned on the mover 1130, particularly, an outer surface of the holder 1131. With this configuration, the tilting guide unit 1141 may be easily coupled to the first housing 1120 and the mover 1130 by the coupling strength generated by a magnetic force between the second magnet 1143 and the first magnet 1142 disposed therein. In the present invention, positions of the first magnet 1142 and the second magnet 1143 may be interchangeable. In addition, an attractive force or a repulsive force may be generated between the first magnet and the second magnet depending on polarity. In the present embodiment, an attractive force may be generated between the first magnet and the second magnet, and thus the mover may maintain the position in the housing.

The first driving unit 1150 includes the driving magnet 1151, the driving coil 1152, the Hall sensor unit 1153, and the first board unit 1154.

The driving magnet 1151 may include a plurality of magnets. In an embodiment, the driving magnet 1151 may include a third magnet 1151a, a fourth magnet 1151b, and a fifth magnet 1151c.

The third magnet 1151a, the fourth magnet 1151b, and the fifth magnet 1151c may each be positioned on the outer surface of the holder 1131. In addition, the third magnet 1151a and the fourth magnet 1151b may be positioned to face each other. In addition, the fifth magnet 1151c may be positioned on a bottom surface of the outer surface of the holder 1131. Detailed description thereof will be made below.

The driving coil 1152 may include a plurality of coils. In an embodiment, the driving coil 1152 may include the third coil 1152a, the fourth coil 1152b, and the fifth coil 1152c.

The third coil 1152a may be positioned to face the third magnet 1151a. Therefore, the third coil 1152a may be positioned in the first housing hole 1121a of the first housing side portion 1121 as described above.

In addition, the fourth coil 1152b may be positioned to face the fourth magnet 1151b. Therefore, the fourth coil 1152b may be positioned in the second housing hole 1122a of the second housing side portion 1122 as described above.

The third coil 1152a may be positioned to face the fourth coil 1152b. In other words, the third coil 1152a may be symmetrically positioned with the fourth coil 1152b with respect to the first direction (X-axis direction). This may also be applied to the third magnet 1151a and the fourth magnet 1151b in the same manner. In other words, the third magnet 1151a and the fourth magnet 1151b may be symmetrically disposed with respect to the first direction (X-axis direction). In addition, at least portions of the third coil 1152a, the fourth coil 1152b, the third magnet 1151a, and the fourth magnet 1151b may be disposed to overlap in the second direction (Y-axis direction). With this configuration, the X-axis tilting may be accurately performed without being biased to one side by the electromagnetic force between the third coil 1152a and the fourth magnet 1151a and the electromagnetic force between the fourth coil 1152b and the fourth magnet 1151b.

The fifth coil 1152c may be positioned to face the fifth magnet 1151c. Therefore, the fifth coil 1152c may be positioned in the third housing hole 1123a of the third housing side portion 1123 as described above. The fifth coil 1152c may generate an electromagnetic force with the fifth magnet 1151c to allow the mover 1130 and the rotating unit 1140 to perform Y-axis tilting with respect to the first housing 1120.

Here, X-axis tilting is tilting with respect to the X-axis, and Y-axis tilting is tilting with respect to the Y-axis.

The Hall sensor unit 1153 may include a plurality of Hall sensors. In an embodiment, the Hall sensor unit 1153 may include a first sub-sensor 1153a, a second sub-sensor 1153b, and a third sub-sensor 1153c. Each sub-sensor may be formed of one or more sub-sensors.

The first sub-sensor 1153a may be positioned inside the third coil 1152a. In addition, the second sub-sensor 1153b may be disposed symmetrically with the first sub-sensor 1153a in the first direction (X-axis direction) and the third direction (Z-axis direction). In addition, the second sub-sensor 1153b may be positioned inside the fourth coil 1152b.

The first sub-sensor 1153a may detect a change in magnetic flux inside the third coil 1152a. In addition, the second sub-sensor 1153b may detect a change in magnetic flux in the fourth coil 1152b. Therefore, it is possible to perform position sensing between the third and fourth magnets 1151a and 1151b and the first and second sub-sensors 1153a and 1153b. For example, the first and second sub-sensors 1153a and 1153b may detect the change in magnet fluxes, and thus the first camera actuator according to the embodiment may control the X-axis tilting.

In addition, the third sub-sensor 1153c may be positioned inside the fifth coil 1152c. The third sub-sensor 1153c may detect a change in magnetic flux inside the fifth coil 1152c. Therefore, it is possible to perform position sensing between the fifth magnet 1151c and the third sub-sensor 1153c. Therefore, the first camera actuator according to the embodiment may control the Y-axis tilting.

The first board unit 1154 may be positioned under the first driving unit 1150. The first board unit 1154 may be electrically connected to the driving coil 1152 and the Hall sensor unit 1153. For example, the first board unit 1154 may be coupled to the driving coil 1152 and the Hall sensor unit 1153 by a surface mount technology (SMT). However, the present invention is not limited to this method.

The first board unit 1154 may be positioned between the first shield can (not shown) and the first housing 1120 and coupled to the shield can 1101 and the first housing 1120. The coupling method may be variously performed as described above. In addition, through the above coupling, the driving coil 1152 and the Hall sensor unit 1153 may be positioned in an outer surface of the first housing 1120.

The first board unit 1154 may include a circuit board having wiring patterns which may be electrically connected, such as a rigid printed circuit board (rigid PCB), a flexible PCB, or a rigid-flexible PCB. However, the present invention is not limited to these types.

Detailed descriptions of the Hall sensor unit 1153 and the first board unit 1154 to be described below will be made below.

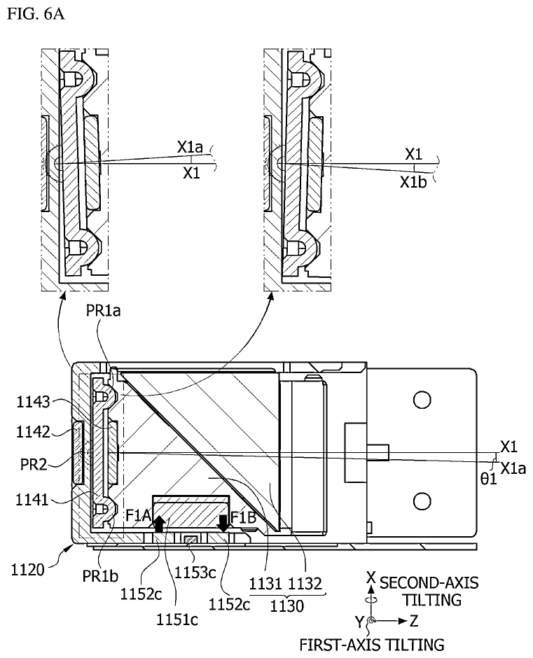

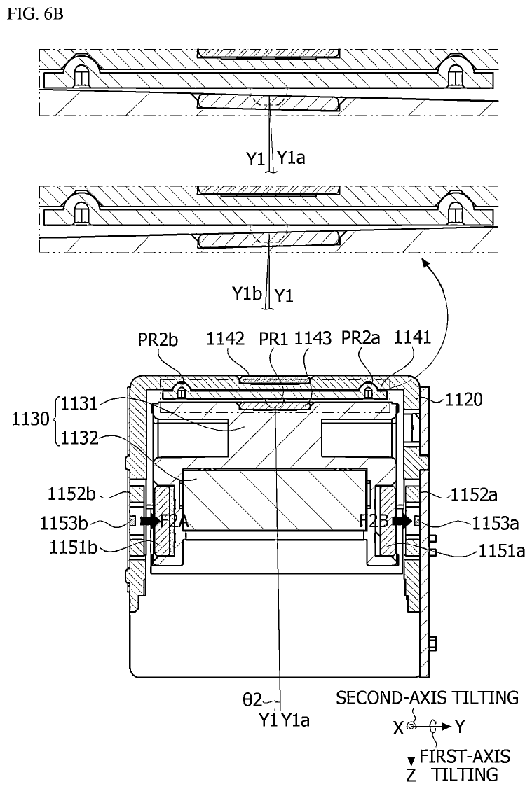

FIG. 5 is a perspective view of the first camera actuator according to the embodiment from which a shield can and a board are removed, FIG. 6A is a cross-sectional view along line BB′ in FIG. 5, and FIG. 6B is a cross-sectional view along line CC′ in FIG. 5.

Referring to FIGS. 5 to 6B, the third coil 1152a may be positioned on the first housing side portion 1121.

In addition, the third coil 1152a and the third magnet 1151a may be positioned to face each other. At least a portion of the third magnet 1151a may overlap the third coil 1152a in the second direction (Y-axis direction).

In addition, the fourth coil 1152b may be positioned on the second housing side portion 1122. Therefore, the fourth coil 1152b and the fourth magnet 1151b may be positioned to face each other. At least a portion of the fourth magnet 1151b may overlap the fourth coil 1152b in the second direction (Y-axis direction).

In addition, the third coil 1152a and the fourth coil 1152b may overlap each other in the second direction (Y-axis direction), and the third magnet 1151a and the fourth magnet 1151b may overlap each other in the second direction (Y-axis direction). With this configuration, the electromagnetic force applied to the outer surfaces of the holder (the first holder outer surface and the second holder outer surface) may be positioned on an axis parallel to the second direction (Y-axis direction) to allow the X-axis tilting to be performed accurately and precisely.

In addition, a first accommodating groove (not shown) may be positioned in the fourth holder outer surface. In addition, first protruding portion PR1a and PR1b may be disposed in the first accommodating groove. Therefore, when the X-axis tilting is performed, the first protruding portion PR1a and PR1b may serve as reference axes (or rotational axes) of the tilting. Therefore, the tilting guide unit 1141 and the mover 1130 may move laterally.

As described above, the second protruding portion PR2 may be seated in a groove of the inner surface of the fourth housing side portion 1124. In addition, when the Y-axis tilting is performed, the rotating plate and the mover may be rotated using the second protruding portion PR2 as a reference axis of the Y-axis tilting.

According to the embodiment, an OIS can be performed by the first protruding portion and the second protruding portion.

Referring to FIG. 6A, the Y-axis tilting may be performed. In other words, an OIS can be implemented by rotating the first camera actuator in the first direction (X-axis direction).

In an embodiment, the fifth magnet 1151c disposed under the holder 1131 may generate the electromagnetic force with the fifth coil 1152c to tilt or rotate the mover 1130 in the first direction (X-axis direction).

Specifically, the tilting guide unit 1141 may be coupled to the first housing 1120 and the mover 1130 by the first magnet 1142 in the first housing 1120 and the second magnet 1143 in the mover 1130. In addition, the first protruding portions PR1 may be spaced apart from each other in the first direction (X-axis direction) and supported by the first housing 1120.

In addition, the tilting guide unit 1141 may rotate or tilt using the second protruding portion PR2 protruding toward the mover 1130 as a reference axis (or a rotational axis). In other words, the tilting guide unit 1141 may perform the Y-axis tilting using the second protruding portion PR2 as the reference axis.

For example, an OIS can be implemented by rotating (X1→X1a or X1b) the mover 1130 at a first angle θ1 in the X-axis direction by first electromagnetic forces F1A and F1B between the fifth magnet 1151c disposed in the third seating groove and the fifth coil 1152c disposed on the third board side portion. The first angle θ1 may be in the range of ±1° to ±3°. However, the present invention is not limited thereto.

Hereinafter, in the first camera actuators according to various embodiments, the electromagnetic force may move the mover by generating a force in the described direction or move the mover in the described direction even when a force is generated in another direction. In other words, the described direction of the electromagnetic force is a direction of the force generated by the magnet and the coil to move the mover.

Referring to FIG. 6B, the X-axis tilting may be performed. In other words, an OIS can be implemented by rotating the mover 1130 in the second direction (Y-axis direction).

The OIS can be implemented by tilting or rotating (or X-axis tilting) the mover 1130 in the Y-axis direction.

In an embodiment, the third magnet 1151a and the fourth magnet 1151b disposed in the holder 1131 may tilt or rotate the tilting guide unit 1141 and the mover 1130 in the second direction (Y-axis direction) by generating the electromagnetic force with the third coil 1152a and the fourth coil 1152b, respectively.

The tilting guide unit 1141 may rotate or tilt (X-axis tilting) in the second direction using the first protruding portion PR1 as a reference axis (or a rotational axis).

For example, an OIS can be implemented by rotating (Y1→Y1a or Y1b) the mover 130 at a second angle θ2 in the Y-axis direction by second electromagnetic forces F2A and F2B between the third and fourth magnets 1151a and 1151b disposed in the first seating groove and the third and fourth coils 1152a and 1152b disposed on the first and second board side portions. The second angle θ2 may be in the range of ±1° to ±3°. However, the present invention is not limited thereto.

In addition, as described above, the electromagnetic forces generated by the third and fourth magnets 1151a and 1151b and the third and fourth coils 1152a and 1152b may act in the third direction or in a direction opposite to the third direction. For example, the electromagnetic force may be generated on a left side portion of the mover 1130 in the third direction (Z-axis direction) and may act on a right side portion of the mover 1130 in the direction opposite to the third direction (Z-axis direction). Therefore, the mover 1130 may rotate with respect to the first direction. Alternatively, the mover 130 may move in the second direction.

As described above, the second camera actuator according to the embodiment may control the tilting guide unit 1141 and the mover 1130 to rotate in the first direction (X-axis direction) or second direction (Y-axis direction) by the electromagnetic force between the driving magnet in the holder and the driving coil disposed in the housing, thereby minimizing the occurrence of a decentering or tilting phenomenon and providing the best optical characteristics upon implementing the OIS. In addition, as described above, “Y-axis tilting” corresponds to rotation or tilting in the first direction (X-axis direction), and “X-axis tilting” corresponds to rotation or tilting in the second direction (Y-axis direction)

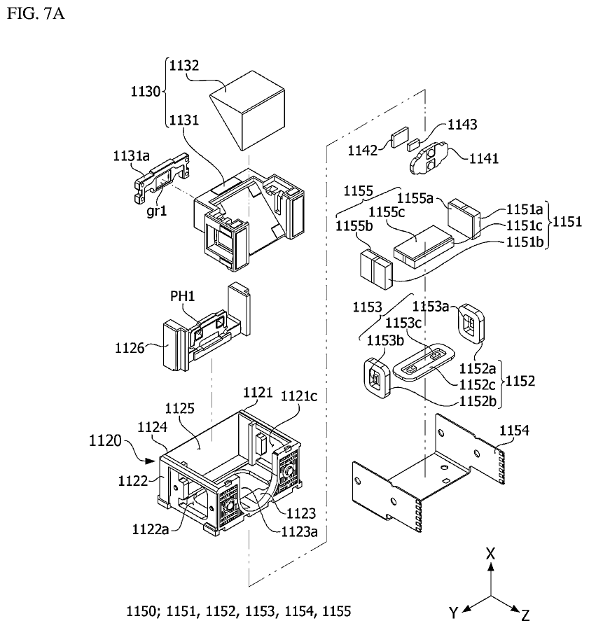

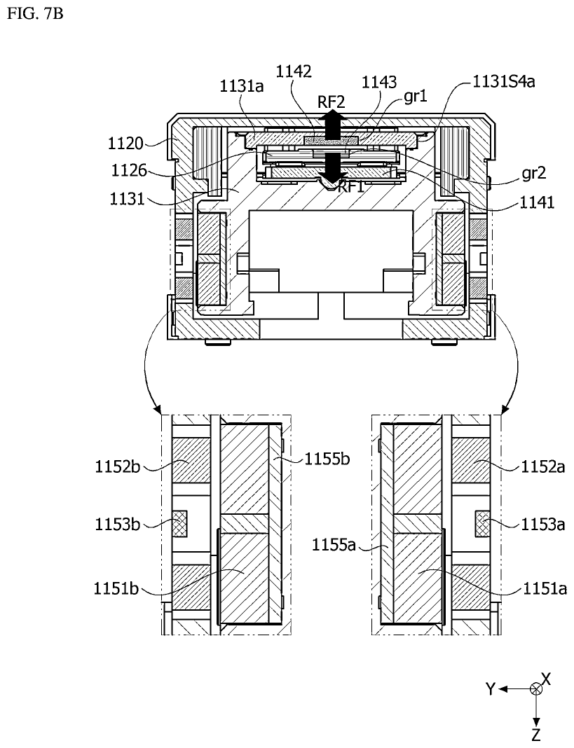

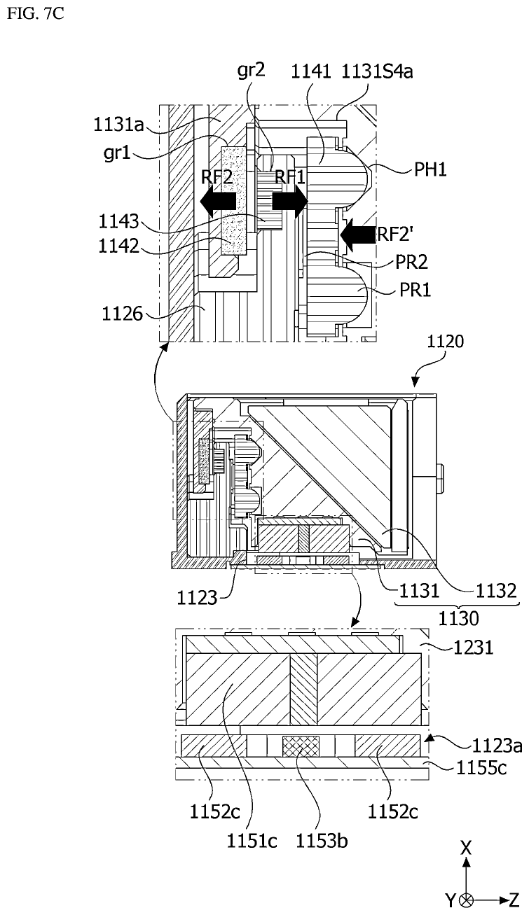

FIG. 7A is an exploded perspective view of a first camera actuator according to another embodiment, FIG. 7B is one cross-sectional view of the first camera actuator according to another embodiment, and FIG. 7C is another cross-sectional view of the first camera actuator according to another embodiment.

Referring to FIGS. 7A and 7C, the first camera actuator 1100 according to another embodiment includes the first housing 1120, the mover 1130, the rotating unit 1140, the first driving unit 1150, a first member 1126, and a second member 1131a.

The mover 1130 may include the holder 1131 and the optical member 1132 seated on the holder 1131. In addition, the mover 1130 may be disposed in the first housing 1120. In addition, the rotating unit 1140 may include the tilting guide unit 1141, and the second magnet 1143 and the first magnet 1142 having different polarities to press the tilting guide unit 1141. The first magnet 1142 and the second magnet 1143 may have different sizes. In an embodiment, the first magnet 1142 may have a larger size than the second magnet 1143. For example, the first magnet 1143 and the second magnet 1143 may have the same length in the optical axis direction or the third direction (Z-axis direction) and have different areas in the first direction and the second direction. In this case, the area of the first magnet 1142 may be larger than the area of the second magnet 1143. In addition, the first driving unit 1150 includes the driving magnet 1151, the driving coil 1152, the Hall sensor unit 1153, the first board unit 1154, and a yoke unit 1155.

First, the first camera actuator 1100 may include the shield can (not shown). The shield can (not shown) may be positioned at an outermost side of the first camera actuator 1100 and positioned to surround the rotating unit 1140 and the first driving unit 1150, which will be described below.

The shield can (not shown) can block or reduce electromagnetic waves generated from the outside. In other words, the shield can (not shown) can reduce the occurrence of malfunction in the rotating unit 1140 or the first driving unit 1150.

The first housing 1120 may be positioned inside the shield can (not shown). When there is no shield can, the first housing 1120 may be positioned at the outermost side of the first camera actuator.

In addition, the first housing 1120 may be positioned inside the first board unit 1154 to be described below. The first housing 1120 may be fastened by being fitted into or matched with the shield can (not shown).

The first housing 1120 may include the first housing side portion 1121, the second housing side portion 1122, the third housing side portion 1123, and the fourth housing side portion 1124. Detailed description thereof will be made below.

The first member 1126 may be disposed in the first housing 1120. The first member 1126 may be disposed between the second member 1131a and the housing. The first member 1126 may be disposed in the housing or positioned at one side of the housing. A description thereof will be made below.

The mover 1130 may include the holder 1131 and the optical member 1132 seated on the holder 1131.

The holder 1131 may be seated in the accommodating part 1125 of the first housing 1120. The holder 1131 may include the first holder outer surface to the fourth holder outer surface respectively corresponding to the first housing side portion 1121, the second housing side portion 1122, the third housing side portion 1123, and the first member 1126. For example, the first holder outer surface to the fourth holder outer surface may correspond to or face inner surfaces of the first housing side portion 1121, the second housing side portion 1122, the third housing side portion 1123, and the first member 1126, respectively.

In addition, the holder 1131 may include the second member 1131a disposed in a fourth seating groove. Detailed description thereof will be made below.

The optical member 1132 may be seated on the holder 1131. To this end, the holder 1131 may have the seating surface, and the seating surface may be formed by the accommodating groove. In an embodiment, the optical member 1132 may be formed of a mirror or a prism. Hereinafter, the optical member 1132 is shown as being the prism, but may be formed of a plurality of lenses as in the above-described embodiment. Alternatively, the optical member 1132 may be formed of the plurality of lenses and the prism or the mirror. In addition, the optical member 1132 may include a reflector disposed therein. However, the present invention is not limited thereto.

In addition, the optical member 1132 may reflect light reflected from the outside (e.g., an object) into the camera module. In other words, the optical member 1132 can resolve the spatial limitations of the first camera actuator and the second camera actuator by changing the path of the reflected light. Therefore, it should be understood that the camera module may provide a high range of magnification by extending the optical path while minimizing a thickness thereof.

Additionally, the second member 1131a may be coupled to the holder 1131. The second member 1131a may be disposed outside the holder 1131 and inside the housing. In addition, the second member 1131a may be seated in an additional groove positioned in an area other than the fourth seating groove of the fourth holder outer surface of the holder 1131. Therefore, the second member 1131a may be coupled to the holder 1131, and at least a portion of the first member 1126 may be positioned between the second member 1131a and the holder 1131. For example, the at least a portion of the first member 1126 may pass through a space formed between the second member 1131a and the holder 1131.

In addition, the second member 1131a may be structured to be spaced apart from the holder 1131. With this configuration, the first camera actuator may be easily assembled as will be described below. Alternatively, the second member 1131a may be integrally formed with the holder 1131, but will be described below as the separated structure.

The rotating unit 1140 includes the tilting guide unit 1141, and the first magnet 1142 and the second magnet 1143 having different polarities to press the tilting guide unit 1141.

The tilting guide unit 1141 may be coupled to the mover 1130 and the first housing 1120. Specifically, the tilting guide unit 1141 may be disposed between the holder 1131 and the first member 1126. Therefore, the tilting guide unit 1141 may be coupled to the mover 1130 of the holder 1131 and the first housing 1120. However, unlike the above description, in the present embodiment, the tilting guide unit 1141 may be disposed between the first member 1126 and the holder 1131. Specifically, the tilting guide unit 1141 may be positioned between the first member 1126 and the fourth seating groove of the holder 1131.

In addition, the second magnet 1143 and the first magnet 1142 may be respectively seated in a first groove gr1 formed in the second member 1131a and a second groove gr2 formed in the first member 1126. In the present embodiment, the first groove gr1 and the second groove gr2 may have different positions from the first and second grooves described above in other embodiments. However, the first groove gr1 is positioned in the second member 1131a and moves integrally with the holder, and the second groove gr2 is positioned on the first member 1126 to correspond to the first groove gr1 and coupled to the first housing 1120. Therefore, the following description will be made by interchangeably using these terms.

In addition, the tilting guide unit 1141 may be disposed adjacent to the optical axis. Therefore, the actuator according to another embodiment may easily change the optical path according to first-axis tilting and second-axis tilting, which will be described below.

The tilting guide unit 1141 may include the first protruding portions disposed to be spaced apart from each other in the first direction (X-axis direction) and the second protruding portions disposed to be spaced apart from each other in the second direction (Y-axis direction). In addition, the first protruding portion and the second protruding portion may protrude in opposite directions. Detailed description thereof will be made below. The first protruding portion may protrude toward the mover. In addition, the first protruding portion may extend from a base in the optical axis direction or the third direction (Z-axis direction). In addition, the second protruding portion may protrude in a direction opposite to the first protruding portion. In other words, the second protruding portion may extend in the direction opposite to the optical axis direction or a direction opposite to the third direction (Z-axis direction). In addition, the second protruding portion may extend toward the first member 1126 or the first housing 1120.

In addition, as described above, the second magnet 1143 may be positioned in the second member 1131a. In addition, the first magnet 1142 may be positioned in the first member 1126.

The second magnet 1142 and the first magnet 1142 may have the same polarity. For example, the second magnet 1143 may be a magnet having an N pole, and the first magnet 1142 may be a magnet having an N pole. Alternatively, conversely, the second magnet 1143 may be a magnet having an S pole, and the first magnet 1142 may be a magnet having an S pole.

For example, a first pole surface of the first magnet 1142 and a second pole surface of the second magnet 1143 facing the first pole surface may have the same polarity.

The second magnet 1143 and the first magnet 1142 may generate a repulsive force therebetween due to the above-described polarities. With this configuration, the above-described repulsive force may be applied to the second member 1131a or the holder 1131 coupled to the second magnet 1143 and the first member 1126 or the first housing 1120 coupled to the first magnet 1142. In this case, the repulsive force applied to the second member 1131a may be transmitted to the holder 1131 coupled to the second member 1131a. Therefore, the tilting guide unit 1141 disposed between the second member 1131a and the first member 1126 may be pressed by the repulsive force. In other words, the repulsive force may maintain the position of the tilting guide unit 1141 between the holder 1131 and the first housing 1120 (or the first member 1126). With this configuration, the position between the mover 1130 and the first housing 1120 can be maintained even during X-axis tilting or Y-axis tilting. In addition, the tilting guide unit may be in close contact with the first member 1126 and the holder 1131 by the repulsive force between the first magnet 1142 and the second magnet 1143. The tilting guide unit 1141 may guide the tilting of the mover 1130.

The first driving unit 1150 includes the driving magnet 1151, the driving coil 1152, the Hall sensor unit 1153, the first board unit 1154, and the yoke unit 1155. The above description can be applied to contents thereof except for the contents described in the present embodiment in the same manner.

The third coil 1152a may be positioned on the first housing side portion 1121, and the third magnet 1151a may be positioned on a first holder outer surface 1131S1 of the holder 1131. Therefore, the third coil 1152a and the third magnet 1151a may be positioned to face each other. At least a portion of the third magnet 1151a may overlap the third coil 1152a in the second direction (Y-axis direction).

In addition, the fourth coil 1152b may be positioned the second housing side portion 1122, and the fourth magnet 1151b may be positioned on a second holder outer surface 1131S2 of the holder 1131. Therefore, the fourth coil 1152b and the fourth magnet 1151b may be positioned to face each other. At least a portion of the fourth magnet 1151b may overlap the fourth coil 1152b in the second direction (Y-axis direction).

In addition, the third coil 1152a and the fourth coil 1152b may overlap each other in the second direction (Y-axis direction), and the third magnet 1151a and the fourth magnet 1151b may overlap each other in the second direction (Y-axis direction).

With this configuration, the electromagnetic force applied to the outer surfaces of the holder (the first holder outer surface and the second holder outer surface) may be positioned on an axis parallel to the second direction (Y-axis direction) to allow the X-axis tilting to be performed accurately and precisely.

In addition, a second protruding portion PR2a and PR2b of the tilting guide unit 1141 may be in contact with the first member 1126 of the first housing 1120. The second protruding portion PR2 may be seated in a second protrusion groove PH2 formed in one side surface of the first member 1126. In addition, when the X-axis tilting is performed, the second protruding portion PR2a and PR2b may be a reference axis (or a rotational axis) of the tilting. Therefore, the tilting guide unit 1141 and the mover 1130 may be moved in the second direction.

In addition, as described above, the first sub sensor 1153a may be positioned outside to be electrically connected and coupled to the first board unit 1154. However, the present invention is not limited to such a position.

In addition, the fifth coil 1152c may be positioned on the third housing side portion 1123, and the fifth magnet 1151c may be positioned on a third holder outer surface 1131S3 of the holder 1131. At least portions of the fifth coil 1152c and the fifth magnet 1151c may overlap each other in the first direction (X-axis direction). Therefore, the electromagnetic force between the fifth coil 1152c and the fifth magnet 1151c may be easily controlled.

As described above, the tilting guide unit 1141 may be positioned on a fourth holder outer surface 1131S4 of the holder 1131. In addition, the tilting guide unit 1141 may be seated in a fourth seating groove 1131S4a of the fourth holder outer surface. As described above, the fourth seating groove 1131S4a may include a first area, a second area, and a third area.

The second member 1131a may be positioned in the first area. In other words, the first area may overlap the second member 1131a in the first direction (X-axis direction). In particular, the first area may be an area where a member base unit of the second member 1131a is positioned. In this case, the first area may be positioned on the fourth holder outer surface 1131S4. In other words, the first area may correspond to an area positioned above the fourth seating groove 1131S4a. In this case, the first area may not be one area in the fourth seating groove 1131S4a.

The first member 1126 may be positioned in the second area. In other words, the second area may overlap the first member 1126 in the first direction (X-axis direction).

In addition, the second area may be positioned on the fourth holder outer surface 1131S4 like the first area. In other words, the second area may correspond to an area positioned above the fourth seating groove 1131S4a.

The tilting guide unit may be positioned in the third area. In particular, the base of the tilting guide unit may be positioned in the third area. In other words, the third area may overlap the tilting guide unit (e.g., the base) in the first direction (X-axis direction).

The second member 1131a may be disposed in the first area, and the second member 1131a may include the first groove gr1 formed in the inner surface of the second member 1131a. In addition, the second magnet 1143 may be disposed in the first groove gr1 as described above, and a repulsive force RF2 generated by the second magnet 1143 may be transmitted to the fourth seating groove 1131S4a of the holder 1131 through the second member 1131a (RF2′). Therefore, the holder 1131 may apply a force to the tilting guide unit 1141 in the same direction as the repulsive force RF2 generated by the second magnet 1143.

The first member 1126 may be disposed in the second area. The first member 1126 may include the second groove gr2 facing the first groove gr1. In addition, the first member 1126 may include the second protrusion groove PH2 disposed in a surface corresponding to the second groove gr2. In addition, a repulsive force RF1 generated by the first magnet 1142 may be applied to the first member 1126. Therefore, the first member 1126 and the second member 1131a may press the tilting guide unit 1141 disposed between the first member 1126 and the holder 1131 through the generated repulsive forces RF1 and RF2′. Therefore, even after the holder tilts with respect to the X-axis or the Y-axis by a current applied to the third and fourth coils or the fifth coil 1152c, the coupling between the holder 1131, the first housing 1120, and the tilting guide unit 1141 can be maintained.

The tilting guide unit 1141 may be disposed in the third area. As described above, the tilting guide unit 1141 may include the first protruding portion PR1 and the second protruding portion PR2. In this case, the first protruding portion PR1 and the second protruding portion PR2 may be disposed on a second surface 1141b and a first surface 1141a of the base, respectively. As described above, even in another embodiment to be described below, the first protruding portion PR1 and the second protruding portion PR2 may be variously positioned on the surface facing the base.

The first protrusion groove PH1 may be positioned in the fourth seating groove 1131S4a. In addition, the first protruding portion PR1 of the tilting guide unit 1141 may be accommodated in the first protrusion groove PH1. Therefore, the first protruding portion PR1 may be in contact with the first protrusion groove PH1. A maximum diameter of the first protrusion groove PH1 may correspond to a maximum diameter of the first protruding portion PR1. This can also be applied to the second protrusion groove PH2 and the second protruding portion PR2 in the same manner. In other words, a maximum diameter of the second protrusion groove PH2 may correspond to a maximum diameter of the second protruding portion PR2. In addition, the second protruding portion PR2 may be in contact with the second protrusion groove PH2. With this configuration, the first-axis tilting may be easily performed with respect to the first protruding portion PR1, the second-axis tilting may be easily performed with respect to the second protruding portion PR2, and the tilting radius can be increased.

In addition, since the tilting guide unit 1141 may be disposed side by side with the second member 1131a and the first member 1126 in the third direction (Z-axis direction), the tilting guide unit 1141 may overlap the optical member 1132 in the first direction (X-axis direction). More specifically, in an embodiment, the first protruding portion PR1 may overlap the optical member 1132 in the first direction (X-axis direction). Furthermore, at least a portion of the first protruding portion PR1 may overlap the fifth coil 1152c or the fifth magnet 1151c in the first direction (X-axis direction). In other words, in the camera actuator according to the embodiment, each protruding portion, which is the central axis of the tilting, may be positioned adjacent to the center of gravity of the mover 1130. Therefore, the tilting guide unit may be positioned adjacent to the center of gravity of the holder. Therefore, the camera actuator according to the embodiment can minimize a moment value at which the holder is tilted and also minimize the consumption of the current applied to the coil unit or the like to tilt the holder, thereby minimizing power consumption and improving the reliability of the device.

In addition, the second magnet 1143 and the first magnet 1142 may not overlap the third coil 1152c or the optical member 1132 in the first direction (X-axis direction). In other words, in an embodiment, the second magnet 1143 and the first magnet 1142 may be disposed to be spaced apart from the third coil 1152c or the optical member 1132 in the third direction (Z-axis direction). Therefore, it is possible to minimize the magnetic force transmitted from the second magnet 1143 and the first magnet 1142 to the fifth coil 1152c. Therefore, the camera actuator according to the embodiment may easily perform vertical driving (Y-axis tilting) and can minimize power consumption.

Furthermore, as described above, the second Hall sensor 1153b positioned inside the fifth coil 1152c may detect a change in magnetic flux, and thus perform position sensing between the fifth magnet 1151c and the second Hall sensor 1153b. In this case, an offset voltage of the second Hall sensor 1153b may be changed depending on the influence of the magnetic field generated from the second magnet 1143 and the first magnet 1142.

In the first camera actuator according to the embodiment, the second member 1131a, the second magnet 1143, the first magnet 1142, the first member 1126, the tilting guide unit 1141, and the holder 1131 are sequentially arranged. However, since the second magnetic part is positioned in the second member and the first magnetic part is positioned in the first member, the second member, the first member, the tilting guide part, and the holder may be sequentially disposed.

In addition, in an embodiment, separation distances of the first magnet 1142 and the second magnet 1143 from the holder 1131 (or the optical member 1132) in the third direction may be larger than separation distances from the tilting guide unit 1141. Therefore, the second Hall sensor 1153b under the holder 1131 may also be disposed to be spaced a predetermined distance from the second magnet 1143 and the first magnet 1142. Therefore, it is possible to minimize the influence of the magnetic field generated by the second magnet 1143 and the first magnet 1142 on the second Hall sensor 1153b, thereby preventing the Hall voltage from being saturated by being concentrated to a positive or negative value. In other words, such a configuration may allow a Hall electrode to have a range in which Hall calibration may be performed. Furthermore, a temperature also affects the electrode of the Hall sensor, and resolution power of a camera lens varies depending on the temperature, but in an embodiment, it is possible to prevent the case in which the Hall voltage is concentrated to the positive or negative value to compensate the resolution power of the lens correspondingly, thereby easily preventing degradation of the resolution power.

In addition, a circuit for compensating for the offset with respect to the output (i.e., the Hall voltage) of the second Hall sensor 1153b may also be easily designed.

In addition, according to the embodiment, some areas of the tilting guide unit 1141 may be positioned outside the fourth holder outer surface as compared to the fourth holder outer surface of the holder 1131.

The tilting guide unit 1141 excluding the first protruding portion PR1 and the second protruding portion PR2 may be seated in the fourth seating groove 1131S4a with respect to the base. In other words, a length of the base in the third direction (Z-axis direction) may be smaller than a length of the fourth seating groove 1131S4a in the third direction (Z-axis direction). With this configuration, it is possible to easily realize miniaturization.

In addition, a maximum length of the tilting guide unit 1141 in the third direction (Z-axis direction) may be larger than a length of the fourth seating groove 1131S4a in the third direction (Z-axis direction). Therefore, as described above, an end of the second protruding portion PR2 may be positioned between the fourth holder outer surface and the first member 1126. In other words, at least a portion of the second protruding portion PR2 may be positioned in a direction opposite to the third direction (Z-axis direction) from the holder 1131. In other words, the holder 1131 may be spaced a predetermined distance from the end (portion in contact with the second protrusion groove) of the second protruding portion PR2 in the third direction (Z-axis direction).

With this configuration, since the second member 1131a is positioned inside or to surround the first member 1126, it is possible to increase space efficiency and realize miniaturization. Furthermore, even when the driving (tilting or rotation of the mover 1130) by the electromagnetic force is performed, the second member 1131a does not protrude outward from the first member 1126, and thus it is possible to prevent the second member 1131a from being in contact with nearby devices. Therefore, it is possible to improve the reliability.

In addition, a predetermined separation space may be present between the second magnet 1143 and the first magnet 1142. In other words, the second magnet 1143 and the first magnet 1142 may face each other with the same polarity.

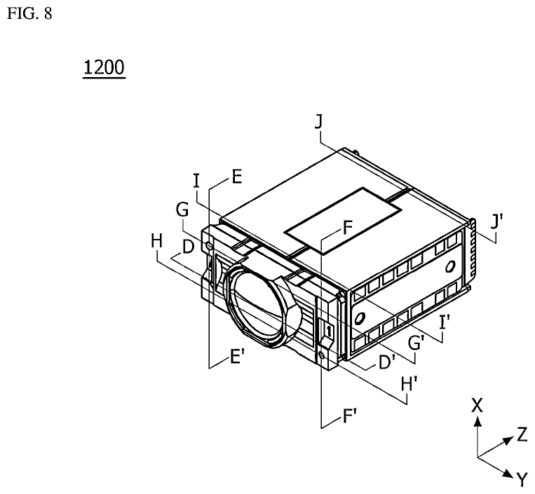

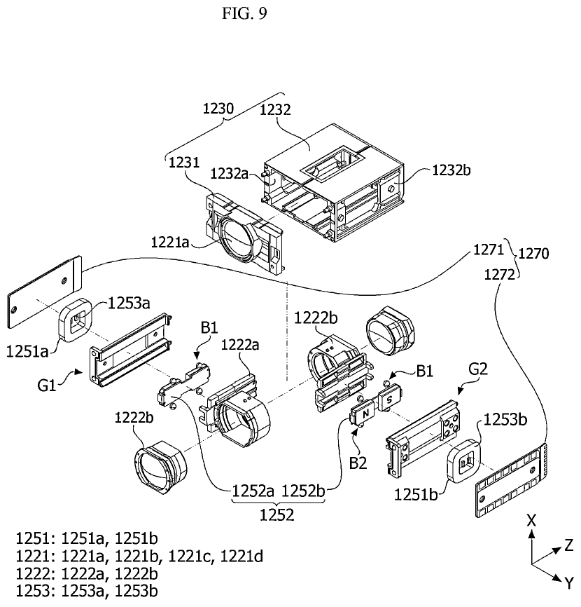

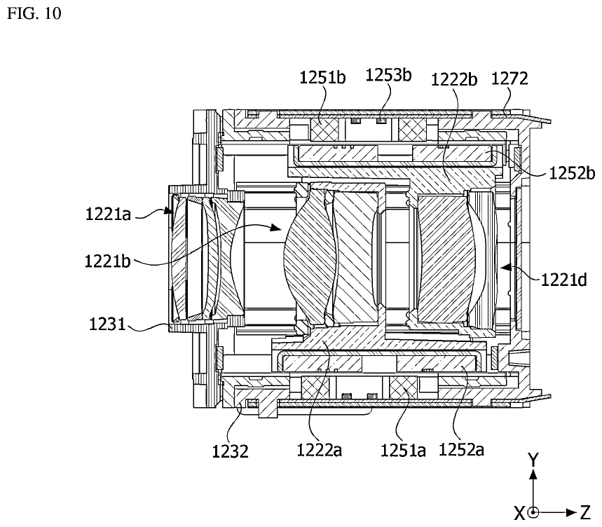

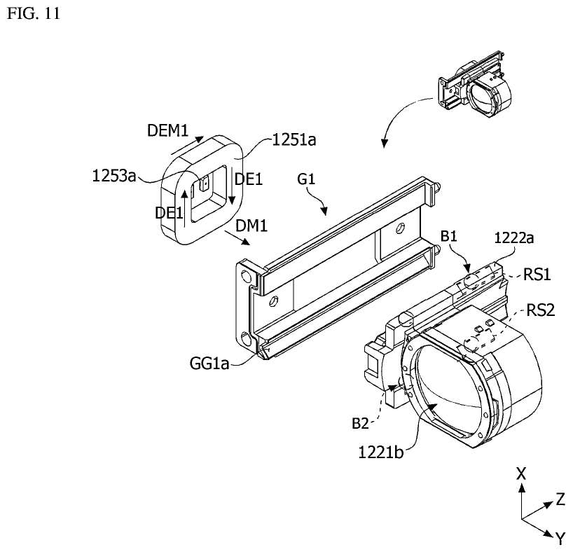

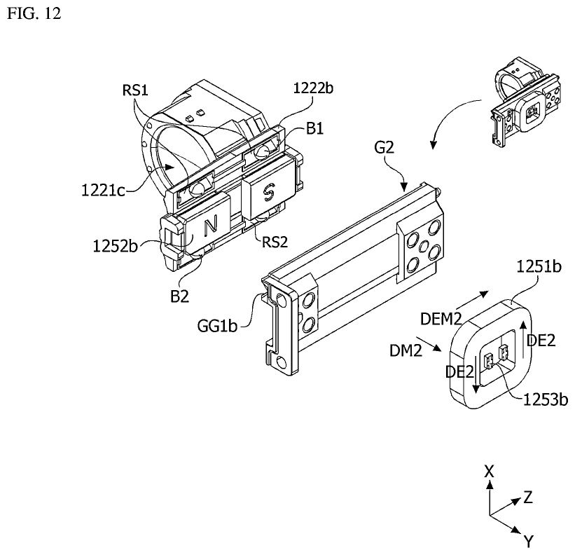

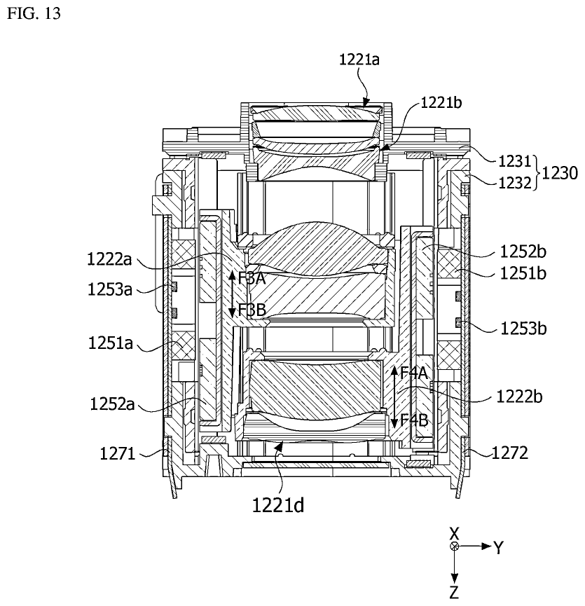

FIG. 8 is a perspective view of a second camera actuator according to an embodiment, FIG. 9 is an exploded perspective view of the second camera actuator according to the embodiment, FIG. 10 is a cross-sectional view along line DD′ in FIG. 8, FIGS. 11 and 12 are views for describing each driving operation of a lens assembly according to an embodiment, and FIG. 13 is a view for describing a driving operation of the second camera actuator according to the embodiment.

Referring to FIGS. 8 to 10, the second camera actuator 1200 according to the embodiment may include a lens unit 1220, a second housing 1230, a second driving unit 1250, a base unit 1260, a second board unit 1270, and a bonding member 1280. Furthermore, the second camera actuator 1200 may further include a second shield can (not shown), an elastic unit (not shown), and a bonding member (not shown).

The second shield can (not shown) may be positioned in one area (e.g., an outermost side) of the second camera actuator 1200 and positioned to surround the components (the lens unit 1220, the second housing 1230, the second driving unit 1250, the base unit 1260, the second board unit 1270, and an image sensor IS) to be describe below.

The second shield can (not shown) can block or reduce electromagnetic waves generated from the outside. Therefore, it is possible to reduce the occurrence of malfunction in the second driving unit 1250.

The lens unit 1220 may be positioned in the second shield can (not shown). The lens unit 1220 may move in the third direction (Z-axis direction or optical axis direction). Therefore, the above-described AF function or zooming function can be performed.

In addition, the lens unit 1220 may be positioned in the second housing 1230. Therefore, at least a portion of the lens unit 1220 may move in the second housing 1230 in the optical axis direction or third direction (Z-axis direction).

Specifically, the lens unit 1220 may include a lens group 1221 and a moving assembly 1222.

First, the lens group 1221 may include at least one lens. In addition, although a plurality of lens groups 1221 may be provided, the following description will be made based on one lens group.

The lens group 1221 may be coupled to the moving assembly 1222 to be moved in the third direction (Z-axis direction) by an electromagnetic force generated from a first magnet 1252a and a second magnet 1252b coupled to the moving assembly 1222.

In an embodiment, the lens group 1221 may include a first lens group 1221a, a second lens group 1221b, and a third lens group 1221c. The first lens group 1221a, the second lens group 1221b, and the third lens group 1221c may be sequentially disposed in the optical axis direction. Furthermore, the lens group 1221 may further include a fourth lens group 1221d. The fourth lens group 1221d may be disposed at a rear end of the third lens group 1221c.

The first lens group 1221a may be fixedly coupled to a 2-1 housing. In other words, the first lens group 1221a may not move in the optical axis direction.

The second lens group 1221b may be coupled to a first lens assembly 1222a to move in the third direction or optical axis direction. Magnification adjustment may be performed by moving the first lens assembly 1222a and the second lens group 1221b.

The third lens group 1221c may be coupled to the second lens assembly 1222b to move in the third direction or optical axis direction. Focus adjustment or auto focusing may be performed by moving the third lens group 1221c.

However, the present invention is not limited to the number of lens groups, and the fourth lens group 1221d may not be present, or additional lens groups or the like other than the fourth lens group 1121d may be further disposed.

The moving assembly 1222 may include an opening area surrounding the lens group 1221. The moving assembly 1222 is used interchangeably with the lens assembly. In addition, the moving assembly 1222 may be coupled to the lens group 1221 by any of various methods. In addition, the moving assembly 1222 may include a groove in a side surface thereof and may be coupled to the first magnet 1252a and the second magnet 1252b through the groove. A coupling member or the like may be applied to the groove.

In addition, the moving assembly 1222 may be coupled to the elastic unit (not shown) at each of an upper end and a rear end thereof. Therefore, the moving assembly 1222 may be supported by the elastic units (not shown) while moving in the third direction (Z-axis direction). In other words, a position of the moving assembly 1222 may be maintained, and the moving assembly 1222 may move in the third direction (Z-axis direction). The elastic unit (not shown) may be formed of various elastic elements such as a leaf spring.

The moving assembly 1222 may be positioned in the second housing 1230 and may include the first lens assembly 1222a and a second lens assembly 1222b.

An area of the second lens assembly 1222b where the third lens group is seated may be positioned at a rear end of the first lens assembly 1222a. In other words, the area of the second lens assembly 1222b where the third lens group 1221c is seated may be positioned between an area of the first lens assembly 1222a where the second lens group 1221b is seated and the image sensor.

The first lens assembly 1222a and the second lens assembly 1222b may face a first guide unit G1 and a second guide unit G2, respectively. The first guide unit G1 and the second guide unit G2 may be positioned on a first side portion and a second side portion of the second housing 1230 to be described below. Detailed description thereof will be made below.

In addition, a second driving magnet may be seated on each of outer surfaces of the first lens assembly 1222a and the second lens assembly 1222b. For example, the second magnet 1252b may be seated on the outer surface of the second lens assembly 1222b. The first magnet 1252a may be seated on the outer surface of the first lens assembly 1222a.

The second housing 1230 may be disposed between the lens unit 1220 and the second shield can (not shown). In addition, the second housing 1230 may be disposed to surround the lens unit 1220.

The second housing 1230 may include a 2-1 housing 1231 and a 2-2 housing 1232. The 2-1 housing 1231 may be coupled to the first lens group 1221a and may also be coupled to the above-described first camera actuator. The 2-1 housing 1231 may be positioned in front of the 2-2 housing 1232. The 2-1 housing 1231 may be referred to as “front housing member” or “first housing member,” and the 2-2 housing 1232 may be referred to as “rear housing member” or “second housing member.” Furthermore, as will be described below, the 2-2 housing 1232 may include a first sub-housing 1232a and a second sub-housing 1232b.

In addition, the 2-2 housing 1232 may be positioned at a rear end of the 2-1 housing 1231. The lens assembly may be seated inside the 2-2 housing 1232.

A hole may be formed in a side portion of the second housing 1230 (or the 2-2 housing 1232). A first coil 1251a and a second coil 1251b may be disposed in the hole. The hole may be positioned to correspond to the above-described groove of the moving assembly 1222.

In an embodiment, the second housing 1230 (in particular, the 2-2 housing 1232) may include a first side portion 1232a and a second side portion 1232b. The first side portion 1232a and the second side portion 1232b may be positioned to correspond to each other. For example, the first side portion 1232a and the second side portion 1232b may be symmetrically disposed with respect to the third direction. A second driving coil 1251 may be positioned on the first side portion 1232a and the second side portion 1232b. In addition, the second board unit 1270 may be seated on each of outer surfaces of the first side portion 1232a and the second side portion 1232b. In other words, a first board 1271 may be positioned on the outer surface of the first side portion 1232a, and a second board 1272 may be positioned on the outer surface of the second side portion 1232b.

Furthermore, the first guide unit G1 and the second guide unit G2 may be positioned on the first side portion 1232a and the second side portion 1232b of the second housing 1230 (in particular, the 2-2 housing 1232).

The first guide unit G1 and the second guide unit G2 may be positioned to correspond to each other. For example, the first guide unit G1 and the second guide unit G2 may be positioned to face each other with respect to the third direction (Z-axis direction). In addition, at least portions of the first guide unit G1 and the second guide unit G2 may overlap each other in the second direction (Y-axis direction).

The first guide unit G1 and the second guide unit G2 may include at least one groove (e.g., a guide groove) or recess. In addition, a first ball B1 or a second ball B2 may be seated in the groove or the recess. Therefore, the first ball B1 or the second ball B2 may move in the guide groove of the first guide unit G1 or the guide groove of the second guide unit G2 in the third direction (Z-axis direction).

Alternatively, the first ball B1 or the second ball B2 may move in the third direction along a rail formed inside the first side portion 1232a of the second housing 1230 or a rail formed inside the second side portion 1232b of the second housing 1230.

Therefore, the first lens assembly 1222a and the second lens assembly 1222b may move in the third direction.

According to the embodiment, the first ball B1 may be disposed on an upper side portion of the first lens assembly 1222a or the second lens assembly 1222b. In addition, the second ball B2 may be disposed on a bottom side portion of the first lens assembly 1222a or the second lens assembly 1222b. For example, the first ball B1 may be positioned above the second ball B2. Therefore, at least a portion of the first ball B1 may overlap the second ball B2 in the first direction (X-axis direction) depending on a position.

In addition, the first guide unit G1 and the second guide unit G2 may include first guide grooves GG1a and GG2a facing a first recess RS1. In addition, the first guide unit G1 and the second guide unit G2 may include second guide grooves GG1b and GG2b facing a second recess RS2. The first guide grooves GG1a and GG2a and the second guide grooves GG1b and GG2b may be grooves extending in the third direction (Z-axis direction). In addition, the first guide grooves GG1a and GG2a and the second guide grooves GG1b and GG2b may have different shapes. For example, the first guide grooves GG1a and GG2a may be grooves having inclined side surfaces, and the second guide grooves GG1b and GG2b may be grooves having side surfaces perpendicular to bottom surfaces thereof.

The second magnet 1252b may be positioned to face the second coil 1251b. In addition, the first magnet 1252a may be positioned to face the first coil 1251a.

The elastic unit (not shown) may include a first elastic member (not shown) and a second elastic member (not shown). The first elastic member (not shown) may be coupled to an upper surface of the moving assembly 1222. The second elastic member (not shown) may be coupled to a bottom surface of the moving assembly 1222. In addition, the first elastic member (not shown) and the second elastic member (not shown) may be formed of a leaf spring as described above. In addition, the first elastic member (not shown) and the second elastic member (not shown) may provide elasticity for moving the moving assembly 1222. However, the present invention is not limited to the above-described position, and the elastic unit may be disposed at any position.

In addition, the second driving unit 1250 may provide a driving force for moving the lens unit 1220 in the third direction (Z-axis direction). The second driving unit 1250 may include a second driving coil 1251 and a second driving magnet 1252. Furthermore, the second driving unit 1250 may further include a second Hall sensor unit. The second Hall sensor unit 1253 may include at least one fourth Hall sensor 1253a and may be positioned inside or outside the second driving coil 1251.

The moving assembly may be moved in the third direction (Z-axis direction) by an electromagnetic force generated between the second driving coil 1251 and the second driving magnet 1252.

The second driving coil 1251 may include a first coil 1251a and a second coil 1251b. The first coil 1251a and the second coil 1251b may be disposed in holes formed in the side portions of the second housing 1230. In addition, the first coil 1251a and the second coil 1251b may be electrically connected to the second board unit 1270. Therefore, the first coil 1251a and the second coil 1251b may receive a current or the like through the second board unit 1270.

The second driving magnet 1252 may include a first magnet 1252a and a second magnet 1252b. The first magnet 1252a and the second magnet 1252b may be disposed in the above-described groove of the moving assembly 1222 and positioned to correspond to the first coil 1251a and the second coil 1251b.

The base unit 1260 may be positioned between the lens unit 1220 and the image sensor IS. A component such as a filter may be fixed to the base unit 1260. In addition, the base unit 1260 may be disposed to surround the above-described image sensor. With this configuration, since the image sensor is free from foreign substances and the like, it is possible to improve the reliability of the device. However, the following description will be made without this in some drawings.

In addition, the second camera actuator 1200 may be a zoom actuator or an AF actuator. For example, the second camera actuator 1200 may support one lens or a plurality of lenses and perform an AF function or a zooming function by moving the lenses according to a predetermined control signal of a control unit.

In addition, the second camera actuator may be a fixed zoom or a continuous zoom. For example, the second camera actuator may provide the movement of the lens group 1221.

In addition, the second camera actuator may be formed of a plurality of lens assemblies. For example, in addition to the first lens assembly 1222a and the second lens assembly 1222b, at least one of a third lens assembly (not shown) and the guide pin (not shown) may be disposed in the second camera actuator. The above-described contents can be applied thereto. Therefore, the second camera actuator may perform a high-magnification zooming function through the second driving unit. For example, the first lens assembly 1222a and the second lens assembly 1222b may be moving lenses which move through the second driving unit and the guide pin (not shown), and the third lens assembly (not shown) may be a fixed lens, but the present invention is not limited thereto. For example, the third lens assembly (not shown) may perform a function of a focator by which light forms an image at a specific position, and the first lens assembly may perform a function of a variator for re-forming an image formed by the third lens assembly (not shown), which is the focator, at another position. Meanwhile, the first lens assembly may be in a state in which a magnification change is large because a distance to a subject or an image distance is greatly changed, and the first lens assembly, which is the variator, may play an important role in a focal length or magnification change of the optical system. Meanwhile, imaging points of an image formed by the first lens assembly, which is the variator, may be slightly different depending on a position. Therefore, the second lens assembly may perform a position compensation function for the image formed by the variator. For example, the second lens assembly may perform a function of a compensator for accurately forming an image at an actual position of the image sensor using the imaging points of the image formed by the second lens assembly 1222b which is the variator. However, the configuration of the embodiment will be described with reference to the following drawings.

The image sensor may be positioned inside or outside the second camera actuator. As shown in an embodiment, the image sensor may be positioned outside the second camera actuator. For example, the image sensor may be positioned on a circuit board. The image sensor may receive light and convert the received light into an electrical signal. In addition, the image sensor may include a plurality of pixels in the form of an array. In addition, the image sensor may be positioned on the optical axis.

The second board unit 1270 may be in contact with the second housing side portion. For example, the second board unit 1270 may be positioned on an outer surface (first side surface) of the first side portion and an outer surface (second side surface) of the second side portion of the second housing, in particular, the 2-2 housing and may be in contact with the first side surface and the second side surface.

Referring to FIGS. 11 and 12, in the camera device according to the embodiment, the first lens assembly 1222a may be moved along a rail positioned on the inner surface of the housing through the first ball B1 in a direction parallel to the optical axis, that is, the third direction (Z-axis direction) or a direction opposite to the third direction by an electromagnetic force DEM1 generated between the first magnet 1252a and the first coil 1251a.

Specifically, in the camera module according to the embodiment, the first magnet 1252a may be provided in the first lens assembly 1222a, for example, by a vertical unipolar magnetization method. For example, in an embodiment, both of an N pole and S pole of the first magnet 1252a may be positioned to face the first coil 1251a. Therefore, each of the N pole and S pole of the first magnet 1252a may be disposed to correspond to an area where a current flows from the first coil 1251a in the X-axis direction or a direction opposite to the X-axis direction.

In an embodiment, when a magnetic force is applied from the N pole of the first magnet 1252a in a direction opposite to the second direction (Y-axis direction) and a current DE1 flows at the first coil 1251a corresponding to the N pole in a direction opposite to the first direction (X-axis direction), the electromagnetic force DEM1 may act in the third direction (Z-axis direction) according to the interaction of the electromagnetic force (e.g., Fleming's left hand rule).

In addition, in an embodiment, when a magnetic force is applied from the S pole of the first magnet 1252a in the second direction (Y-axis direction) and the current DE1 flows at the first coil 1251a corresponding to the S pole in the first direction (X-axis direction), the electromagnetic force DEM1 may act in the Z-axis direction according to the interaction of the electromagnetic force.

At this time, since the first coil 1251a is in a state of being fixed to the second housing side portion, the first lens assembly 1222a on which the first magnet 1252a is disposed may move in the direction opposite to the Z-axis direction by the electromagnetic force DEM1 according to the current direction. In other words, the second driving magnet may move in an opposite direction of the electromagnetic force applied to the second driving coil. In addition, the direction of the electromagnetic force may be changed depending on the current of the coil and the magnetic force of the magnet.

Therefore, the first lens assembly 1222a may move along the rail positioned on the inner surface of the housing through the first ball B1 in a direction (both directions) parallel to the third direction or the optical axis direction. At this time, the electromagnetic force DEM1 may be controlled in proportion to the current DE1 applied to the first coil 1251a.

The first lens assembly 1222a or the second lens assembly 1222b may include the first recess RS1 in which the first ball B1 is seated. In addition, the first lens assembly 1222a or the second lens assembly 1222b may include the second recess RS2 in which the second ball B2 is seated. A length of the first recess RS1 in the optical axis direction (Z-axis direction) may be preset. In addition, a length of the second recess RS2 in the optical axis direction (Z-axis direction) may be preset. Therefore, moving distances of the first ball B1 and the second ball B2 in the optical axis direction in each recess may be adjusted. In other words, the first recess RS1 or the second recess RS2 may be a stopper for the first and second balls B1 and B2.

In addition, in the camera device according to the embodiment, the second magnet 1252b may be provided on the second lens assembly 1222b by, for example, the vertical unipolar magnetization method. For example, in an embodiment, both of an N pole and S pole of the second magnet 1252b may be positioned to face the second coil 1251b. Therefore, each of the N pole and S pole of the second magnet 1252b may be disposed to correspond to an area where a current flows from the second coil 1251b in the X-axis direction or the direction opposite to the X-axis direction.

In an embodiment, when a magnetic force DM2 is applied from the N pole of the second magnet 1252b in the second direction (Y-axis direction) and the current DE2 flows at the second coil 1251b corresponding to the N pole in the first direction (X-axis direction), an electromagnetic force DEM2 may act in the third direction (Z-axis direction) according to the interaction of the electromagnetic force (e.g., Fleming's left hand rule).

In addition, in an embodiment, when a magnetic force is applied from the S pole of the second magnet 1252b in a direction opposite to the second direction (Y-axis direction) and the current DE2 flows at the second coil 1251b corresponding to the S pole in a direction opposite to the first direction (X-axis direction), the electromagnetic force DEM2 may act in the Z-axis direction according to the interaction of the electromagnetic force.

At this time, since the second coil 1251b is in a state of being fixed to the second housing side portion, the second lens assembly 1222b on which the second magnet 1252b is disposed may move in the direction opposite to the Z-axis direction by the electromagnetic force DEM2 according to the current direction. For example, as described above, the direction of the electromagnetic force may be changed depending on the current of the coil and the magnetic force of the magnet. Therefore, the second lens assembly 1222b may move along the rail positioned on the inner surface of the second housing through the second ball B2 in a direction parallel to the third direction (Z-axis direction). At this time, the electromagnetic force DEM2 may be controlled in proportion to the current DE2 applied to the second coil 1251b.

Referring to FIG. 13, in the camera device according to the embodiment, the second driving unit may provide driving forces F3A, F3B, F4A, and F4B which move the first lens assembly 1222a and the second lens assembly 1222b of the lens unit 1220 in the third direction (Z-axis direction). As described above, the second driving unit may include the second driving coil 1251 and the second driving magnet 1252. In addition, the lens unit 1220 may be moved in the third direction (Z-axis direction) by the electromagnetic force generated between the second driving coil 1251 and the second driving magnet 1252.

At this time, the first coil 1251a and the second coil 1251b may be disposed in the holes formed in the side portions (e.g., the first side portion and the second side portion) of the second housing 1230. In addition, the second coil 1251b may be electrically connected to the first board 1271. The first coil 1251a may be electrically connected to the second board 1272. Therefore, the first coil 1251a and the second coil 1251b may receive a driving signal (e.g., a current) from a driving driver on the circuit board 1300 through the second board unit 1270.

At this time, the first lens assembly 1222a on which the first magnet 1252a is seated may move in the third direction (Z-axis direction) by the electromagnetic forces F3A and F3B between the first coil 1251a and the first magnet 1252a. In addition, the second lens group 1221b seated on the first lens assembly 1222a may also move in the third direction.

In addition, the second lens assembly 1222b on which the second magnet 1252b is seated may be moved in the third direction (Z-axis direction) by the electromagnetic forces F4A and F4B between the second coil 1251b and the second magnet 1252b. In addition, the third lens group 1221c seated on the second lens assembly 1222b may also move in the third direction.

Therefore, as described above, a focal length or magnification of the optical system may be changed by moving the second lens group 1221b and the third lens group 1221c. In the embodiment, the magnification may be changed by moving the second lens group 1221b. In other words, zooming may be performed. In addition, a focus may be adjusted by moving the third lens group 1221c. In other words, auto focusing may be performed. With this configuration, the second camera actuator may be a fixed zoom or a continuous zoom.

FIG. 14 is a schematic diagram showing a circuit board according to an embodiment.

Referring to FIG. 14, as described above, the circuit board 1300 according to the embodiment may include a first circuit board unit 1310 and a second circuit board unit 1320. The first circuit board unit 1310 may be positioned under the base and coupled to the base. In addition, the image sensor IS may be disposed on the first circuit board unit 1310. In addition, the first circuit board unit 1310 and the image sensor IS may be electrically connected.

In addition, the second circuit board unit 1320 may be positioned on a side portion of the base. In particular, the second circuit board unit 1320 may be positioned on a first side portion of the base. Therefore, the second circuit board unit 1320 may be positioned adjacent to the first coil positioned adjacent to the first side portion for easy electrical connection.

Furthermore, the circuit board 1300 may further include a fixed board (not shown) positioned on a side surface thereof. Therefore, even when the circuit board 1300 is made of a flexible material, the circuit board 1300 may be coupled to the base while maintaining stiffness by the fixed board.

The second circuit board unit 1320 of the circuit board 1300 may be positioned on the side portion of the second driving unit 1250. The circuit board 1300 may be electrically connected to the first driving unit and the second driving unit. For example, the electrical connection may be made by the SMT. However, the present invention is not limited to this method.

The circuit board 1300 may include a circuit board having wiring patterns which may be electrically connected, such as a rigid PCB, a flexible PCB, or a rigid-flexible PCB. However, the present invention is not limited to these types.

In addition, the circuit board 1300 may be electrically connected to another camera module in the terminal or a processor of the terminal. Therefore, the above-described camera actuator and camera device including the same may transmit and receive various signals in the terminal.

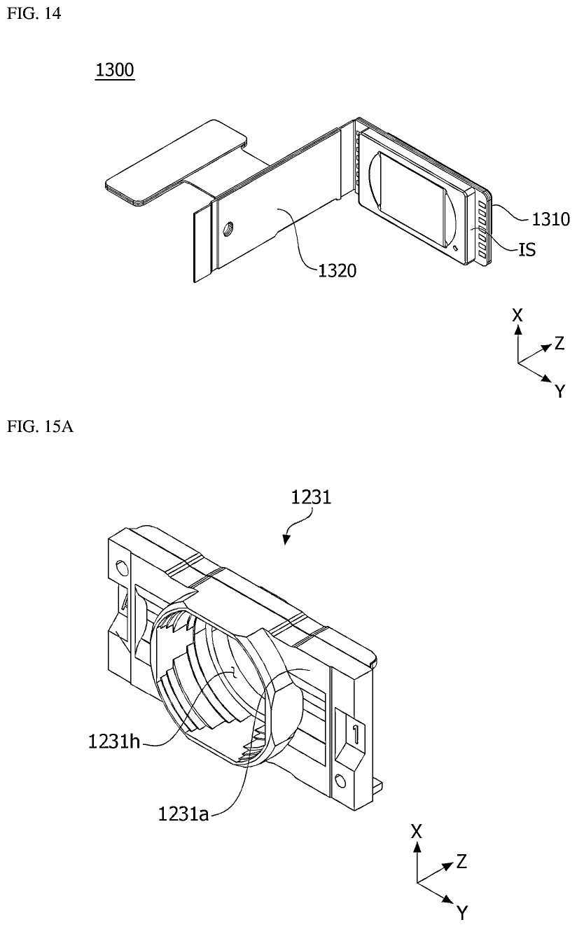

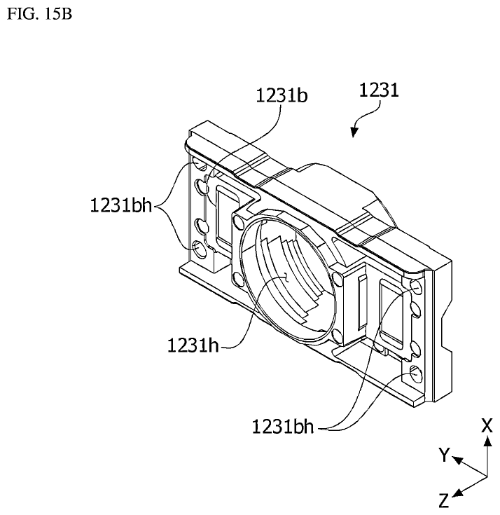

FIG. 15A is one perspective view of a first housing member according to an embodiment, and FIG. 15B is another perspective view of the first housing member according to the embodiment.

First, as described above, the second housing includes a first housing member 1231 and a second housing member 1232 (see FIG. 9). In addition, the first housing member 1231 is positioned at a front end of the second housing member. Alternatively, the first housing member 1231 may be positioned at the first camera actuator side with respect to the second housing member. Alternatively, the second housing member may be positioned adjacent to the image sensor instead of the first housing member 1231.

The first housing member 1231 may include a first member hole 1231a. The first lens group 1221a (see FIG. 9) may be inserted into the first member hole 1231a.

In addition, the first housing member 1231 may include an upper surface 1231a and a bottom surface 1231b. The upper surface 1231a of the first housing member 1231 may face the first camera actuator side. The bottom surface 1231b of the first housing member 1231 may face the image sensor side.

A shape coupled to the first camera actuator at the front end may be formed on the upper surface 1231a of the first housing member 1231. For example, the shape may include various structures such as protrusions and grooves.

A member coupled to the second housing member may be formed on the bottom surface 1231b of the first housing member 1231. For example, the bottom surface 1231b of the first housing member 1231 may include a member groove 1231bh. A plurality of member grooves 1231bh may be disposed along an edge of the bottom surface 1231b of the first housing member 1231. Furthermore, the plurality of member grooves 1231bh may be disposed to be spaced apart from each other in the second direction or the horizontal direction.

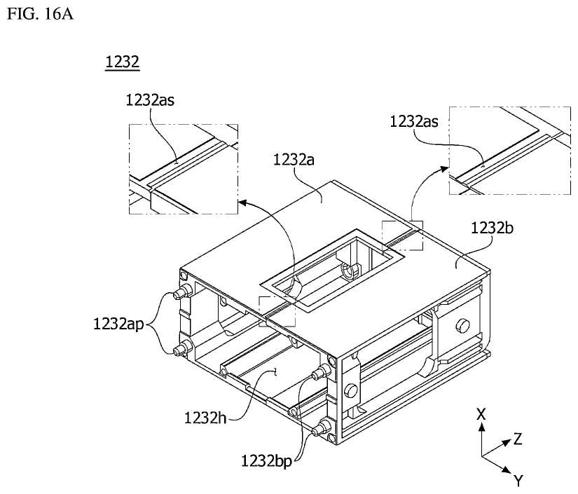

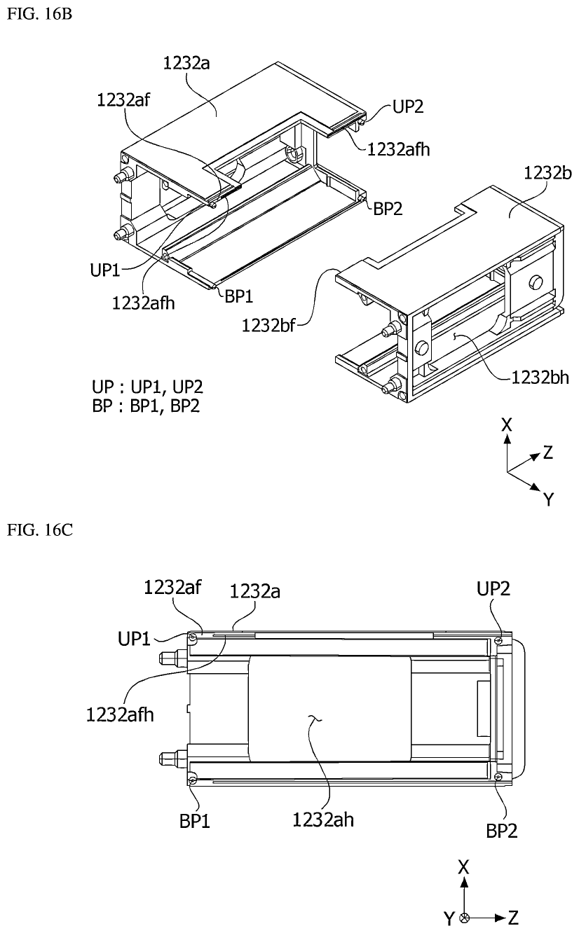

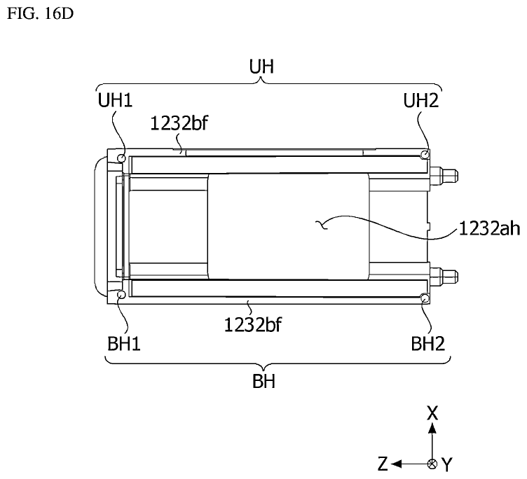

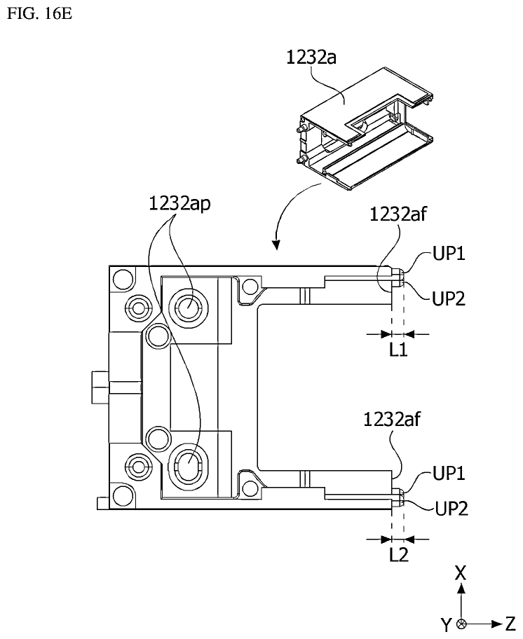

FIG. 16A is a perspective view of a second housing according to an embodiment, FIG. 16B is an exploded perspective view of the second housing member according to the embodiment, FIG. 16C is a perspective view of a first sub-housing of the second housing member according to the embodiment, FIG. 16D is a perspective view of a second sub-housing of the second housing member according to the embodiment, and FIG. 16E is a side view of the second sub-housing of the second housing member according to the embodiment.

Referring to FIGS. 16A to 16E, as described above, the first lens assembly and the second lens assembly moving in the optical axis direction (Z-axis direction) may be disposed in the second housing member 1232. To this end, the second housing member 1232 may include a second member hole 1232h. In addition, the first lens assembly and the second lens assembly may be positioned in the second member hole 1232h.

Furthermore, the second housing member 1232 may include a first sub-housing 1232a and a second sub-housing 1232b. The first sub-housing 1232a may accommodate the first lens assembly or may be coupled to the first lens assembly. The second sub-housing 1232b may accommodate the second lens assembly or may be coupled to the second lens assembly.

The first sub-housing 1232a and the second sub-housing 1232b may be coupled. The first sub-housing 1232a and the second sub-housing 1232b may be disposed side by side in the second direction or horizontal direction. In addition, the first sub-housing 1232a and the second sub-housing 1232b may be spaced apart from each other in some areas in the horizontal direction.

The first sub-housing 1232a may include a first sub-protrusion 1232ap protruding toward the first camera actuator. The second sub-housing 1232b may include a second sub-protrusion 1232bp protruding toward the first camera actuator.

The first sub-protrusion 1232ap and the second sub-protrusion 1232bp may be accommodated in the above-described member groove of the first housing member. Therefore, the first housing member and the second housing member 1232 may be coupled. Furthermore, a bonding member or the like may be applied to the member groove of the first housing member. Therefore, it is possible to increase a coupling strength between the first housing member and the second housing member.

In addition, any one of the first sub-housing 1232a and the second sub-housing 1232b may include a coupling protrusion extending in the horizontal direction. The other of the first sub-housing 1232a and the second sub-housing 1232b may include a coupling groove in which the coupling protrusion is accommodated. The following description will be made based on the fact that the first sub-housing 1232a includes coupling protrusions UP and BP and the second sub-housing 1232b includes coupling grooves UH and BH.

In an embodiment, at least any one of the first sub-housing 1232a and the second sub-housing 1232b may include a surface 1232af facing the other or a bonding groove 1232afh disposed on an outer surface thereof.

The first sub-housing 1232a may include a surface facing the second sub-housing 1232b or an inner surface 1232af. Likewise, the second sub-housing 1232b may include a surface facing the first sub-housing 1232a or an inner surface 1232bf.

The inner surface 1232af of the first sub-housing 1232a may face the inner surface 1232bf of the second sub-housing 1232b. A coupling protrusion may extend from the inner surface 1232af of the first sub-housing 1232a in the second direction or toward the second sub-housing 1232b. In other words, the first sub-housing 1232a may include the coupling protrusions UP and BP extending in the second direction.

In addition, a bonding groove 1232afg may be disposed on the inner surface 1232af of the first sub-housing 1232a. The bonding groove 1232afh may be disposed adjacent to the coupling protrusions UP and BP. With this configuration, the applied bonding member may be easily moved to the bonding groove 1232afh and the coupling protrusions UP and BP. Furthermore, the bonding member may not be excessively applied to the coupling protrusions UP and BP. In addition, the bonding groove 1232afh may have additional protrusions or grooves to prevent an overflow of a bonding member such as epoxy.

The coupling protrusions UP and BP may include the upper coupling protrusion UP and the bottom coupling protrusion BP. A plurality of upper coupling protrusions UP and bottom coupling protrusions BP may be provided.

In addition, the plurality of upper coupling protrusions UP may be provided and spaced apart from each other in the optical axis direction. In addition, at least portions of the plurality of upper coupling protrusions UP may overlap each other in the optical axis direction (Z-axis direction). The plurality of bottom coupling protrusions BP may be provided and spaced apart from each other in the optical axis direction. In addition, at least portions of the plurality of bottom coupling protrusions BP may overlap each other in the optical axis direction (Z-axis direction).

In an embodiment, the upper coupling protrusion UP may include a first upper protrusion UP1 and a second upper protrusion UP2 spaced apart from each other in the optical axis direction. At least portions of the first upper protrusion UP1 and the second upper protrusion UP2 may overlap each other in the optical axis direction (Z-axis direction). In addition, some areas of the first upper protrusion UP1 and the second upper protrusion UP2 may be misaligned (may not overlap each other) in the optical axis direction (Z-axis direction). Therefore, the first sub-housing 1232a and the second sub-housing 1232b can be easily coupled.

Furthermore, a length L1 of the first upper protrusion UP1 in the second direction (Y-axis direction) may be equal to a length L2 of the second upper protrusion UP2 in the second direction (Y-axis direction).

In addition, as a modified example, the length L1 of the first upper protrusion UP1 in the second direction (Y-axis direction) may differ from the length L2 of the second upper protrusion UP2 in the second direction (Y-axis direction). Therefore, the coupling strength can be adjusted.

In addition, in an embodiment, the bottom coupling protrusion BP may include a first bottom protrusion BP1 and a second bottom protrusion BP2 spaced apart from each other in the optical axis direction. At least portions of the first bottom protrusion BP1 and the second bottom protrusion BP2 may overlap each other in the optical axis direction (Z-axis direction). In addition, some areas of the first bottom protrusion BP1 and the second bottom protrusion BP2 may be misaligned in the optical axis direction (Z-axis direction).

In addition, a length of the first bottom protrusion BP1 in the second direction may be equal to a length of the second bottom protrusion BP2 in the second direction.

In addition, the coupling groove corresponding to the coupling protrusion may be positioned on the inner surface 1232bf of the second sub-housing 1232b. The coupling grooves UH and BH may include the upper groove UH and the bottom groove BH. In addition, the upper groove UH may include a first upper groove UH1 and a second upper groove UH2 spaced apart from each other in the optical axis direction. The bottom groove BH may be spaced apart from the upper groove UH in the vertical direction (X-axis direction). Furthermore, the bottom groove BH may overlap the upper groove UH in the vertical direction. The bottom groove BH may include a first bottom groove BH1 and a second bottom groove BH2 spaced apart from each other in the optical axis direction.

At least portions of the first upper groove UH1 and the second upper groove UH2 may overlap each other in the optical axis direction. In addition, some areas of the first upper groove UH1 and the second upper groove UH2 may be misaligned in the optical axis direction.

The first upper groove UH1 may be positioned to correspond to the first upper protrusion UP1. In other words, the first upper groove UH1 may be positioned to face the first upper protrusion UP1. Furthermore, the first upper protrusion UP1 may be inserted into the first upper groove UH1.

The second upper groove UH2 may be positioned to correspond to the second upper protrusion UP2. In other words, the second upper groove UH2 may be positioned to face the second upper protrusion UP2. Furthermore, the second upper protrusion UP2 may be inserted into the second upper groove UH2.

The first bottom groove BH1 may be positioned to correspond to the first bottom protrusion BP1. In other words, the first bottom groove BH1 may be positioned to face the first bottom protrusion BP1. Furthermore, the first bottom protrusion BP1 may be inserted into the first bottom groove BH1.

The second bottom groove BH2 may be positioned to correspond to the second bottom protrusion BP2. In other words, the second bottom groove BH2 may be positioned to face the second bottom protrusion BP2. Furthermore, the second bottom protrusion BP2 may be inserted into the second bottom groove BH2.

Furthermore, upper surfaces of the coupling protrusions UP and BP and bottom surfaces of the coupling grooves UH and BH corresponding to the coupling protrusions may be spaced apart from each other in the horizontal direction (Y-axis direction). In other words, a predetermined space or gap may be present between the upper surfaces of the coupling protrusions UP and BP and the bottom surfaces of the coupling grooves UH and BH corresponding to the coupling protrusions. Detailed description thereof will be made below.

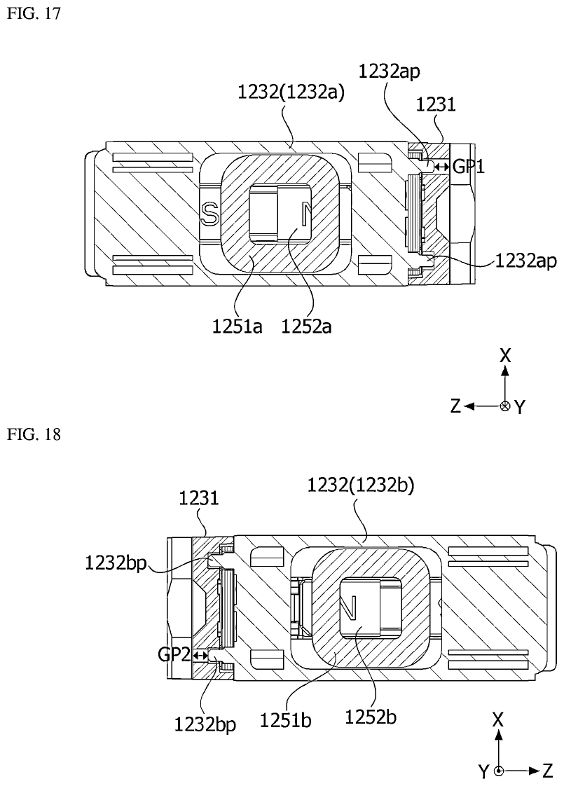

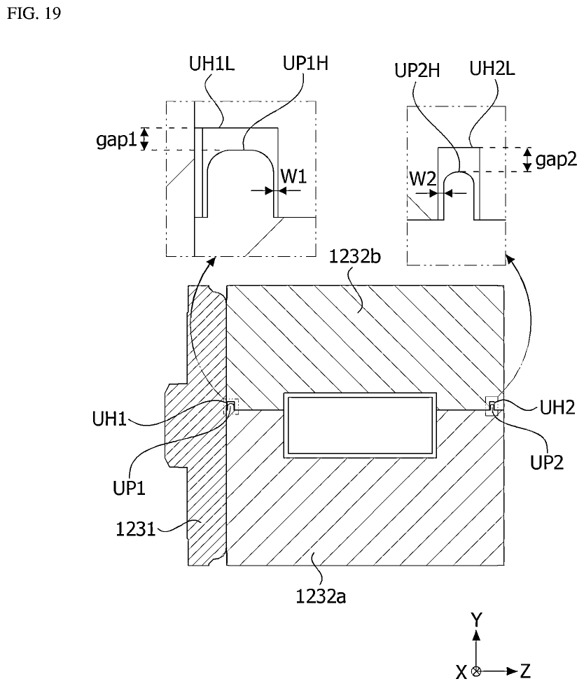

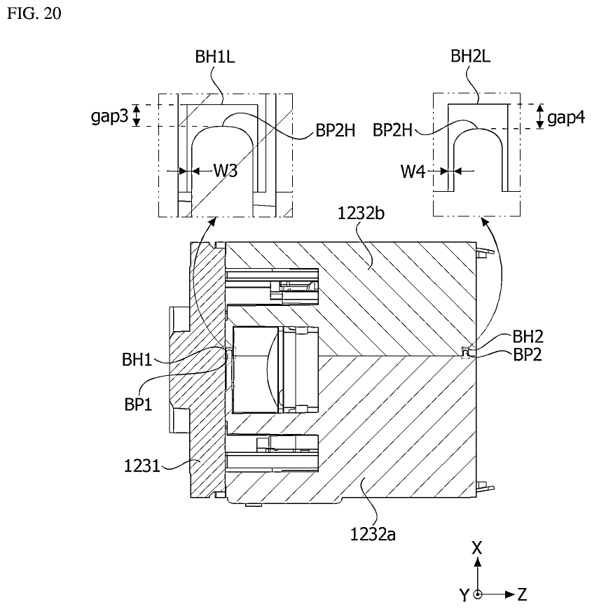

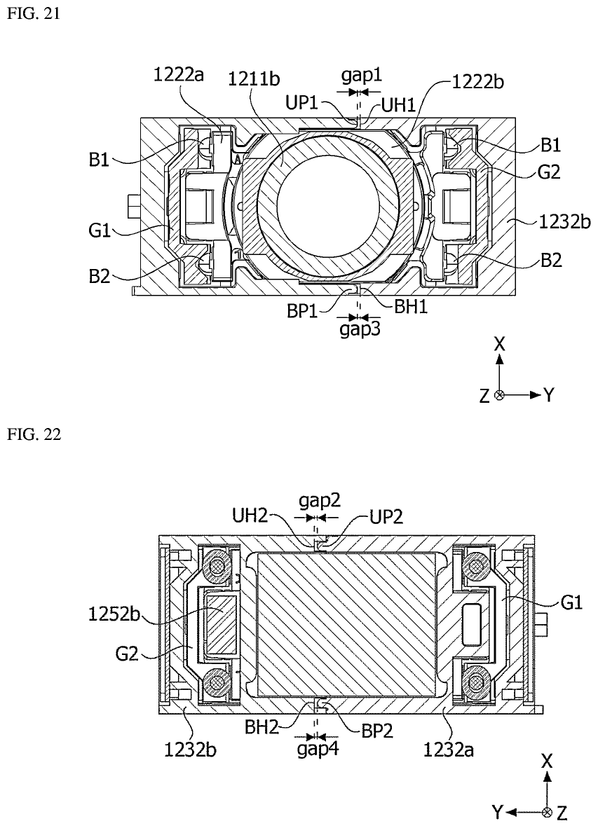

FIG. 17 is a view along line EE′ in FIG. 11, FIG. 18 is a view along line FF′ in FIG. 11, FIG. 19 is a view along line GG′ in FIG. 11, FIG. 20 is a view along line HH′ in FIG. 11, FIG. 21 is a view along line II′ in FIG. 11, and FIG. 22 is a view along line JJ′ in FIG. 11.

Referring to FIGS. 17 and 18, the first sub-protrusion 1232ap and the second sub-protrusion 1232bp may be accommodated in the member groove of the first housing member 1231. In addition, at least one of the first sub-protrusion 1232ap and the second sub-protrusion 1232bp may be spaced a predetermined distance from a bottom surface of the member groove in the member groove of the first housing member 1231 in the optical axis direction (Z-axis direction). For example, a plurality of first sub-protrusions 1232ap may be provided, and at least one of the plurality of first sub-protrusions 1232ap may be spaced a predetermined distance from a bottom surface of the corresponding member groove in the optical axis direction (GP1). In addition, a plurality of second sub-protrusions 1232bp may be provided, and at least one of the plurality of second sub-protrusions 1232bp may be spaced a predetermined distance from a bottom surface of the corresponding member groove in the optical axis direction (GP2). With this configuration, the first sub-housing and the second sub-housing can be easily tilted with respect to the first housing member.

Referring to FIGS. 19 to 22, the upper surfaces of the coupling protrusions UP and BP and the bottom surfaces of the coupling grooves UH and BH corresponding to the coupling protrusions may be spaced apart from each other in the horizontal direction (Y-axis direction). Furthermore, the coupling protrusions UP and BP and the coupling grooves UH and BH may be spaced apart from each other in at least one of the first direction (X-axis direction), the second direction (Y-axis direction), and the third direction (Z-axis direction).

In other words, a predetermined space or gap is present between the upper surfaces of the coupling protrusion UP and BP and the bottom surfaces of the coupling grooves UH and BH corresponding to the coupling protrusions. In other words, maximum widths of the coupling protrusions UP and BP may be smaller than minimum widths of the coupling grooves UH and BH. In other words, diameters (sizes) of the coupling protrusions UP and BP may be smaller than diameters (sizes) of the inner surfaces of the coupling grooves UH and BH. In addition, the outer surfaces of the coupling protrusions UP and BP and the inner surfaces of the coupling grooves UH and BH may be spaced apart from each other.

More specifically, the first upper protrusion UP1 may be accommodated in the first upper groove UH1. In addition, an upper surface UP1H of the first upper protrusion UP1 may be spaced apart from a bottom surface UH1L of the first upper groove UH1 in the horizontal direction (Y-axis direction). Therefore, a gap (gap1) may be present between the upper surface UP1H of the first upper protrusion UP1 and the bottom surface UH1L of the first upper groove UH1.

Furthermore, a maximum width of the first upper protrusion UP1 may be smaller than a minimum width of the first upper groove UH1. Therefore, an outer surface of the first upper protrusion UP1 and an inner surface of the first upper groove UH1 may be spaced a predetermined distance W1 from each other. In this case, the predetermined distance W1 may be in the range of 0.4 mm to 0.6 mm. When the predetermined distance W1 is smaller than or equal to 0.4 mm, it may be difficult to tilt the first or second sub-housing, and when the predetermined distance W1 is larger than 0.6 mm, a coupling strength between the first sub-housing and the second sub-housing can be reduced.

In addition, the second upper protrusion UP2 may be accommodated in the second upper groove UH2. In addition, an upper surface UP2H of the second upper protrusion UP2 may be spaced apart from a front surface UH2L of the second upper groove UH2 in the horizontal direction (Y-axis direction). Therefore, a gap (gap2) may be present between the upper surface UP2H of the second upper protrusion UP2 and the front surface UH2L of the second upper groove UH2.

Furthermore, a maximum width of the second upper protrusion UP2 may be smaller than a minimum width of the second upper groove UH2. Therefore, an outer surface of the second upper protrusion UP2 and an inner surface of the second upper groove UH2 may be spaced a predetermined distance W2 from each other. In this case, the predetermined distance W2 may be in the range of 0.4 mm to 0.6 mm. When the predetermined distance W2 is smaller than or equal to 0.4 mm, it may be difficult to tilt the first or second sub-housing, and when the predetermined distance W2 is larger than 0.6 mm, a coupling strength between the first sub-housing and the second sub-housing can be reduced.

The first bottom protrusion BP1 may be accommodated in the first bottom groove BH1. In addition, an upper surface BP1H of the first bottom protrusion BP1 may be spaced apart from a front surface BH1L of the first bottom groove BH1 in the horizontal direction (Y-axis direction). Therefore, a gap (gap3) may be present between the upper surface BP1H of the first bottom protrusion BP1 and the front surface BH1L of the first bottom groove BH1.

Furthermore, a maximum width of the first bottom protrusion BP1 may be smaller than a minimum width of the first bottom groove BH1. Therefore, an outer surface of the first bottom protrusion BP1 and an inner surface of the first bottom groove BH1 may be spaced a predetermined distance W3 from each other. In this case, the predetermined distance W3 may be in the range of 0.4 mm to 0.6 mm. When the predetermined distance W3 is smaller than or equal to 0.4 mm, it may be difficult to tilt the first or second sub-housing, and when the predetermined distance W3 is larger than 0.6 mm, a coupling strength between the first sub-housing and the second sub-housing can be reduced.

The second bottom protrusion BP2 may be accommodated in the second bottom groove BH2. In addition, an upper surface BP2H of the second bottom protrusion BP2 may be spaced apart from a front surface BH2L of the second bottom groove BH2 in the horizontal direction (Y-axis direction). Therefore, a gap (gap3) may be present between the upper surface BP2H of the second bottom protrusion BP2 and the front surface BH2L of the second bottom groove BH2.

Furthermore, a maximum width of the second bottom protrusion BP2 may be smaller than a minimum width of the second bottom groove BH2. Therefore, an outer surface of the second bottom protrusion BP2 and an inner surface of the second bottom groove BH2 may be spaced a predetermined distance W4 from each other. In this case, the predetermined distance W4 may be in the range of 0.4 mm to 0.6 mm. When the predetermined distance W4 is smaller than or equal to 0.4 mm, it may be difficult to tilt the first or second sub-housing, and when the predetermined distance W4 is larger than 0.6 mm, a coupling strength between the first sub-housing and the second sub-housing can be reduced.

In addition, separation distances or gaps between the upper surfaces of the coupling protrusions UP and BP and the bottom surface of the coupling grooves UH and BH corresponding to or accommodating the coupling protrusions UP and BP may be the same as or different from each other.

As various examples, the distance gap1 between the upper surface UP1H of the first upper protrusion UP1 and the bottom surface UH1L of the first upper groove UH1 may differ from the distance gap2 between the upper surface UP2H of the second upper protrusion UP2 and the bottom surface UH2L of the second upper groove UH1. With this configuration, it is possible to provide optimal optical performance (e.g., an improved modulation transfer function (MTF)) by adjusting the positions (e.g., tilting with respect to the optical axis) between the second lens group and the third lens group with respect to the first lens group. Furthermore, the first sub-housing 1232a and the second sub-housing 1232a can simply provide improved optical performance only by tilting the first sub-housing 1232a and the second sub-housing 1232b with respect to the optical axis direction without adjusting the size or the like of the moving member (e.g., the ball) for moving the second lens group and the third lens group to provide improved optical performance.

In addition, any one of the second lens assembly 1222b and the third lens assembly 1222c may be tilted with respect to the first lens assembly 1222a. In addition, at least two of the first lens assembly 1222a, the second lens assembly 1222b, and the third lens assembly 1222c may be spaced apart from each other.

In addition, the second magnet 1252b coupled to the second lens assembly 1222b may be positioned closer to the image sensor than the first magnet. In other words, when the first lens assembly 1222a and the second lens assembly 1222b are maximally moved adjacent to the image sensor, the second magnet 1252b may be positioned behind the first magnet, that is, adjacent to the image sensor. Therefore, the first lens assembly 1222a may have a larger moving distance in the optical axis direction than the second lens assembly 1222b.

Furthermore, the first sub-housing 1232a and the first guide unit G1 may be separated or integrated as shown in the drawing. Likewise, the second sub-housing 1232b and the second guide unit G2 may be separated or integrated as shown in the drawing.

Therefore, each of the first sub-housing 1232a and the second sub-housing 1232b may be tilted at a predetermined angle with respect to the optical axis. Therefore, the first lens assembly and the second lens group coupled to the first sub-housing 1232a may also tilt or move. In addition, the second lens assembly and the third lens group coupled to the second sub-housing 1232b may also tilt or move. With this configuration, the second lens group and the third lens group may be moved to positions at which improved optical performance can be provided. Therefore, the lens driving device or camera actuator according to the present embodiment can provide easy assembly and improved optical performance.

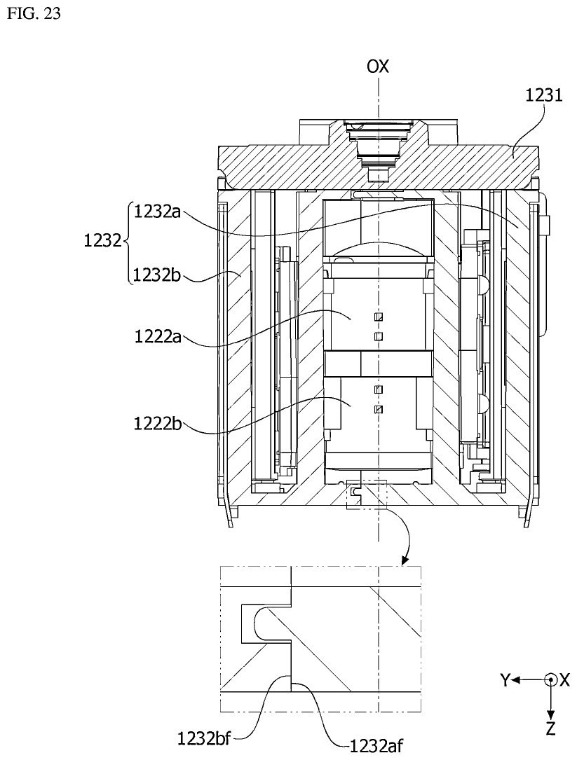

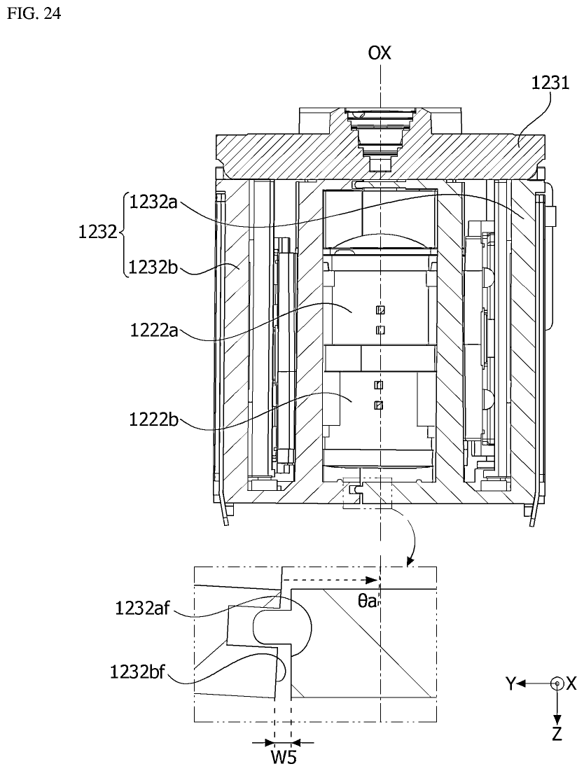

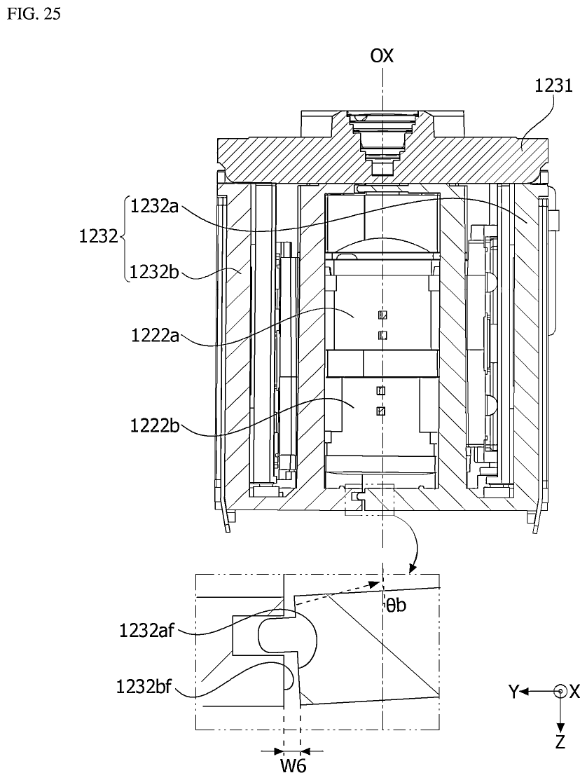

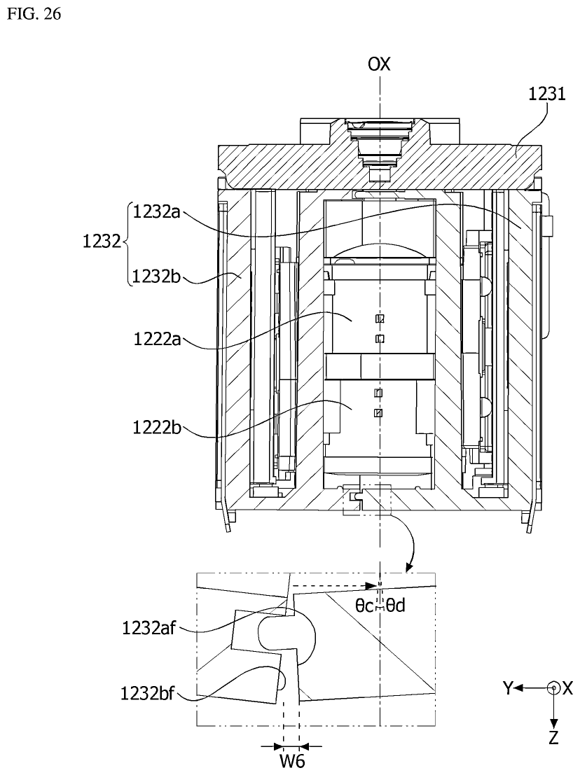

FIG. 23 is a cross-sectional view of a second camera actuator according to an embodiment, FIG. 24 is a cross-sectional view of one aspect of the second camera actuator according to the embodiment, FIG. 25 is a cross-sectional view of another aspect of the second camera actuator according to the embodiment, and FIG. 26 is a cross-sectional view of still another aspect of the second camera actuator according to the embodiment.

Referring to FIGS. 23 to 26, the above-described contents except for contents to be described below can be applied to the second camera actuator according to each embodiment.

Referring to FIG. 23, as described above, the first sub-housing 1232a may include a surface facing the second sub-housing 1232b or an inner surface 1232af. Likewise, the second sub-housing 1232b may include the surface facing the first sub-housing 1232a or the inner surface 1232bf.

The inner surface 1232af of the first sub-housing 1232a and the inner surface 1232bf of the second sub-housing 1232b may be in contact with each other or may be spaced a predetermined distance from each other. In other words, the first sub-housing 1232a and the second sub-housing 1232b may have a predetermined gap. Therefore, as described in the present embodiment, the first sub-housing 1232a and the second sub-housing 1232b may be coupled at a position at which optimal optical performance (MTF) is provided by the tilting of the first sub-housing 1232a and the second sub-housing 1232b. Therefore, the second camera actuator or the lens driving device can provide improved optical performance. For example, after the position at which the optimal optical performance is provided, the first housing member 1231, the first sub-housing 1232a, and the second sub-housing 1232b may be primarily coupled by using a coupling member or a bonding member (e.g., epoxy). In addition, the first sub-housing and the second sub-housing may be coupled by secondarily applying the bonding member to the coupling groove and the coupling protrusion. In this case, in applying and curing the bonding member, the first sub-housing and the second sub-housing may be tilted with respect to the optical axis and cured. For example, when there is no additional lens group or lens assembly behind the second lens assembly or the third lens group (at the image sensor side), only the tilting of the first sub-housing may be performed. Alternatively, when there is the additional lens group or lens assembly behind the second lens assembly or the third lens group (at the image sensor side), the tilting of both the first sub-housing and the second sub-housing may be performed. Therefore, when the first and second lens assemblies move along the optical axis through the ball, a problem that straightness is degraded depending on the flatness of the guide unit or the recess may occur. Furthermore, straightness is also degraded depending on an assembly tolerance. Therefore, assembly becomes complicated when a plurality of balls of various sizes are disposed on the guide unit after optical performance measurement, but simple assembly can be achieved upon tilting the above-described first and second sub-housings. In other words, according to the embodiment, an improved assembly process can be achieved.

Referring to FIGS. 24 to 26, at least one of the first sub-housing 1232a and the second sub-housing 1232b may be tilted at a predetermined angle with respect to the optical axis (or an axis parallel to the optical axis direction) or the first housing member 1231.

For example, as shown in FIG. 24, the second sub-housing 1232b may not be parallel to an optical axis OX or a central axis which bisects the first housing member 1231. In other words, the inner surface 1232bf of the second sub-housing 1232b may be tilted at a predetermined angle θa with respect to the optical axis OX. Alternatively, the first sub-housing 1232a may be parallel to the optical axis OX. In other words, the inner surface 1232af of the first sub-housing 1232a may be positioned parallel to the optical axis OX.

In addition, a separation distance W5 between the inner surface 1232af of the first sub-housing 1232a and the inner surface 1232bf of the second sub-housing 1232b may also increase or decrease in the optical axis direction. For example, the separation distance W5 may gradually increase in the optical axis direction. In other words, a distance between the first sub-housing 1232a and the second sub-housing 1232b may increase or decrease in the optical axis direction.

For example, the separation distance W5 between the inner surface 1232af of the first sub-housing 1232a and the inner surface 1232bf of the second sub-housing 1232b may be different at different points in the optical axis direction. For example, the separation distance in an area adjacent to the first camera actuator may be larger than a separation distance in an area adjacent to the image sensor. In addition, the separation distance in the area adjacent to the first camera actuator may be smaller than the separation distance in the area adjacent to the image sensor.

Referring to FIG. 25, the first sub-housing 1232a may not be parallel to the optical axis OX or the central axis which bisects the first housing member 1231. In other words, the inner surface 1232af of the first sub-housing 1232a may be tilted at a predetermined angle θb with respect to the optical axis OX. Alternatively, the second sub-housing 1232b may be parallel to the optical axis OX. In other words, the inner surface 1232bf of the second sub-housing 1232b may be positioned parallel to the optical axis OX.

In addition, a separation distance W6 between the inner surface 1232bf of the second sub-housing 1232b and the inner surface 1232af of the first sub-housing 1232a may also increase or decrease in the optical axis direction. For example, the separation distance W6 may gradually increase in the optical axis direction. In other words, the distance between the first sub-housing 1232a and the second sub-housing 1232b may increase or decrease in the optical axis direction.

Referring to FIG. 26, the first sub-housing 1232a may not be parallel to the optical axis OX or the central axis which bisects the first housing member 1231. In other words, the inner surface 1232af of the first sub-housing 1232a may be tilted at the predetermined angle θd with respect to the optical axis OX.

In addition, the second sub-housing 1232b may not be parallel to the optical axis OX or the central axis which bisects the first housing member 1231. In other words, the inner surface 1232bf of the second sub-housing 1232b may be tilted at a predetermined angle θc with respect to the optical axis OX.

In addition, a separation distance W7 between the inner surface 1232bf of the second sub-housing 1232b and the inner surface 1232af of the first sub-housing 1232a may also increase or decrease in the optical axis direction. For example, the separation distance W7 may gradually increase in the optical axis direction. Likewise, the distance between the first sub-housing 1232a and the second sub-housing 1232b may increase or decrease in the optical axis direction.

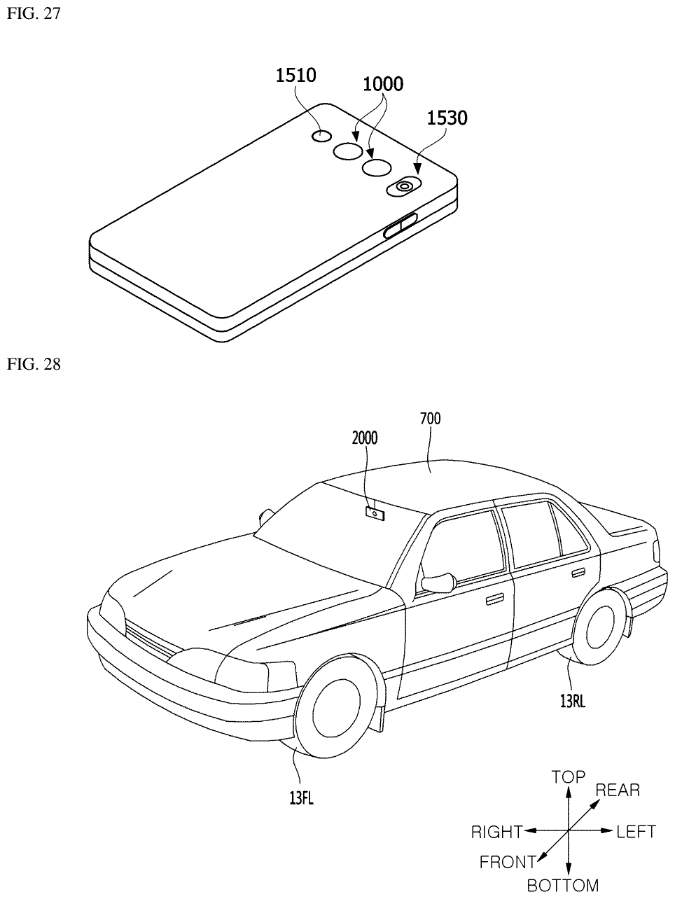

FIG. 27 is a perspective view of a mobile terminal to which the camera device according to the embodiment is applied.

Referring to FIG. 27, a mobile terminal 1500 according to an embodiment may include the camera device 1000, a flash module 1530, and an AF device 1510, which are provided on a rear surface thereof.

The camera device 1000 may include an image photographing function and an AF function. For example, the camera device 1000 may include the AF function using an image.

The camera device 1000 processes an image frame of a still image or a moving image obtained by an image sensor in a photographing mode or a video call mode.

The processed image frame may be displayed on a predetermined display and stored in a memory. A camera (not shown) may also be disposed on a front surface of a body of the mobile terminal.

For example, the camera device 1000 may include a first camera device 1000A and a second camera device 1000B, and the first camera device 1000A may implement an OIS function together with an AF or zooming function.

The flash module 1530 may include a light emitting device for emitting light therein. The flash module 1530 may be operated by a camera operation of the mobile terminal or a user's control.

The AF device 1510 may include one of a package of a surface light emitting laser device as a light emitting unit.

The AF device 1510 may include the AF function using a laser. The AF device 1510 may be mainly used in a condition in which the AF function using the image of the camera device 1000 is degraded, for example, in an environment which is close to 10 m or less or dark.

The AF device 1510 may include a light emitting unit including a vertical cavity surface emitting laser (VCSEL) semiconductor device and a light receiving unit for converting light energy into electrical energy, such as a photodiode.

FIG. 28 is a perspective view of a vehicle to which the camera device according to the embodiment is applied.

For example, FIG. 28 is a view of an exterior of a vehicle including a vehicle driver assistance device to which the camera device 1000 according to the embodiment is applied.

Referring to FIG. 28, a vehicle 700 according to the embodiment may include wheels 13FL and 13FR rotated by a power source and a predetermined sensor. Although the sensor may be a camera sensor 2000, the present invention is not limited thereto.

The camera sensor 2000 may be a camera sensor to which the camera device 1000 according to the embodiment is applied. The vehicle 700 according to the embodiment may acquire image information through the camera sensor 2000 for capturing a forward image or a surrounding image, determine a situation in which a lane line is not identified using the image information, and generate a virtual lane line when the lane line is not identified.

For example, the camera sensor 2000 may acquire a forward image by capturing a view in front of the vehicle 700, and a processor (not shown) may acquire image information by analyzing an object included in the front image.

For example, when a lane line, an adjacent vehicle, a traveling obstacle, and objects, such as a median, a curb, or a tree corresponding to an indirect road mark, are captured in the image captured by the camera sensor 2000, the processor may detect the object and include the detected object in the image information. In this case, the processor may further supplement the image information by acquiring information on a distance from the object detected through the camera sensor 2000.

The image information may be information on the object captured in the image. The camera sensor 2000 may include an image sensor and an image processing module.

The camera sensor 2000 may process still images or moving images obtained by the image sensor (e.g., a complementary metal-oxide semiconductor (CMOS) or a charge-coupled device (CCD)).

The image processing module may process the still images or moving images acquired through the image sensor to extract necessary information, and transmit the extracted information to the processor.

In this case, although the camera sensor 2000 may include a stereo camera in order to improve the measurement accuracy of the object and further secure information such as a distance between the vehicle 700 and the object, the present invention is not limited thereto.

Although embodiments have been mainly described above, these are only illustrative and do not limit the present invention, and those skilled in the art to which the present invention pertains can know that various modifications and applications not exemplified above are possible without departing from the essential characteristics of the embodiments. For example, each component specifically shown in the embodiments may be implemented by modification. In addition, differences related to these modifications and applications should be construed as being included in the scope of the present invention defined in the appended claims.

1. A lens driving device comprising:
a housing including a first housing member, and a second housing member that is coupled to the first housing member and includes a first sub-housing and a second sub-housing;
a first lens assembly coupled to the first sub-housing to move in an optical axis direction, and a second lens assembly coupled to the second sub-housing to move in the optical axis direction; and
a driving unit configured to move the first lens assembly and the second lens assembly.

2. The lens driving device of claim 1, wherein at least one of the first sub-housing and the second sub-housing is tilted at a predetermined angle with respect to the optical axis direction or the first housing member.

3. The lens driving device of claim 1, wherein a distance between the first sub-housing and the second sub-housing increases or decreases in the optical axis direction.

4. The lens driving device of claim 1, wherein any one of the first sub-housing and the second sub-housing includes a coupling protrusion extending in a horizontal direction, and the other includes a coupling groove in which the coupling protrusion is accommodated.

5-10. (canceled)

11. The lens driving device of claim 4, wherein a maximum width of the coupling protrusion is smaller than a minimum width of the coupling groove.

12. The lens driving device of claim 11, wherein an outer surface of the coupling protrusion and an inner surface of the coupling groove are spaced apart from each other.

13. The lens driving device of claim 11, wherein the coupling protrusion includes an upper coupling protrusion and a bottom coupling protrusion.

14. The lens driving device of claim 13, wherein the upper coupling protrusion is provided as a plurality of upper coupling protrusions, and at least some of the upper coupling protrusions overlap each other in the optical axis direction.

15. The lens driving device of claim 14, wherein an upper surface of the upper coupling protrusion and a bottom surface of the coupling groove corresponding to the upper coupling protrusion are spaced apart from each other in the horizontal direction.

16. The lens driving device of claim 14, wherein the upper coupling protrusions include a first upper protrusion and a second upper protrusion spaced apart from each other in the optical axis direction.

17. The lens driving device of claim 16, wherein a length of the first upper protrusion is equal to a length of the second upper protrusion.

18. The lens driving device of claim 17, wherein a distance between an upper surface of the first upper protrusion and a bottom surface of a coupling groove corresponding to the first upper protrusion differs from a distance between an upper surface of the second upper protrusion and a bottom surface of a coupling groove corresponding to the second upper protrusion.

19. The lens driving device of claim 1, wherein at least any one of the first sub-housing and the second sub-housing includes a bonding groove disposed in a surface facing the other or in an inner surface thereof.

20. The lens driving device of claim 19,
wherein any one of the first sub-housing and the second sub-housing includes a coupling protrusion extending in a horizontal direction,
wherein the bonding groove is disposed adjacent to the coupling protrusion.

21. The lens driving device of claim 1,
wherein the first sub-housing and the second sub-housing are disposed side by side in a second direction or a horizontal direction.

22. The lens driving device of claim 1,
wherein the first sub-housing and the second sub-housing are coupled each other.

23. The lens driving device of claim 1,
wherein the first sub-housing and the second sub-housing are spaced apart from each other in some areas in a horizontal direction.

24. The lens driving device of claim 1,
wherein the first sub-housing and the second sub-housing are tilted at a predetermined angle with respect to an optical axis.

25. The lens driving device of claim 1,
wherein a separation distance between the inner surface of the first sub-housing and the inner surface of the second sub-housing are different at different points in an optical axis direction.

26. The lens driving device of claim 1,
wherein an inner surface of the first sub-housing or an inner surface of the second sub-housing is positioned parallel to an optical axis.
